(19) United States
(12) Patent Application Publication
(10) Pub. No.: US 2019/0346671 A1
(43) Pub. Date: Nov. 14, 2019

(54) SHAPE ESTIMATION APPARATUS AND SHAPE ESTIMATION METHOD

(71) Applicant: OLYMPUS CORPORATION, Tokyo (JP)

(72) Inventors: Koichi TAKAYAMA, Kokubunji-shi (JP); Hiromasa FUJITA, Hachioji-shi (JP)

(73) Assignee: OLYMPUS CORPORATION, Tokyo (JP)

(21) Appl. No.: 16/523,065

(22) Filed: Jul. 26, 2019

Related U.S. Application Data
(63) Continuation of application No. PCT/JP2017/002811, filed on Jan. 26, 2017.

(51) Int. Cl. G02B 23/26; G02B 6/42; G02B 23/24

(52) U.S. Cl. CPC G02B 23/26; G02B 6/4266; G02B 23/2476; G02B 6/4262

(57) ABSTRACT

A shape estimation apparatus includes: a light guide to guide light emitted from a light source; a detection target, provided in the light guide, to change a light quantity of guided light according to the curved state of the light guide; a light detector to detect a light quantity that has been changed; and a curvature arithmetic operator to calculate information related to a curve of the light guide based on the detected light quantity. The light detector includes a light receiving element. The operator calculates information related to the curve of the light guide in which an error of the light detector caused by noise containing dark current of the light detector is corrected based on an output of a part of the light receiving element that the light from the light source does not enter.

### CROSS-REFERENCE TO RELATED APPLICATIONS

This application is a Continuation Application of PCT Application No. PCT/JP2017/002811, filed Jan. 26, 2017, the entire contents of which are incorporated herein by reference.

### BACKGROUND OF THE INVENTION

### 1. Field of the Invention

The present invention relates to a shape estimation apparatus configured to estimate a curved shape of a flexible structure and a shape estimation method.

### 2. Description of the Related Art

Jpn. Pat. Appln. KOKAI Publication No. 2016-007505 discloses such a shape estimation apparatus. In this shape estimation apparatus, about wavelengths according respectively to detection targets of light absorbers, various curvatures of detection targets are computed based on estimated light quantity values, each of which is a relationship between a wavelength and a light quantity calculated based on the detection information and a light quantity estimation relationship, using a shape estimation sensor configured to cause a light detector to detect different detection information depending on shapes of the detection targets. Furthermore, the curved shape of the flexible structure in which the shape estimation sensor is incorporated is estimated based on the curvature and position information of each of the detection targets.

### BRIEF SUMMARY OF THE INVENTION

An aspect of the present invention is directed to a shape estimation apparatus configured to estimate a curved shape of a flexible structure. The shape estimation apparatus includes: a light guide configured to guide light emitted from a light source; a detection target provided in the light guide and configured to change a light quantity of light guided by the light guide according to the curved state of the light guide; a light detector including a light receiving element and configured to receive the light that has been changed in a light quantity by the detection target to detect the light quantity; and a curvature arithmetic operator configured to calculate information related to a curve of the light guide based on the detected light quantity. The light receiving element includes a part that the light from the light source does not enter. The curvature arithmetic operator calculates information related to the curve of the light guide in which an error of the light detector caused by noise containing dark current of the light detector is corrected based on an output of the part of the light receiving element that the light from the light source does not enter.

Another aspect of the present invention is directed to another shape estimation apparatus configured to estimate a curved shape of a flexible structure. The shape estimation apparatus configured to estimate a curved shape of a flexible structure, the apparatus includes: a light guide incorporated in the flexible structure and configured to guide light emitted from a light source; a detection target provided in the light guide and configured to change a light quantity of light guided by the light guide according to the curved state of the light guide; a light detector configured to receive the light that has been changed in a light quantity by the detection target to detect the light quantity; and a curvature arithmetic operator configured to calculate information related to a curve of the light guide based on the detected light quantity. The curvature arithmetic operator calculates information related to the curve of the light guide in which an error of the light detector caused by noise containing dark current of the light detector is corrected based on an output of the light detector corresponding to a wavelength range deviated from a wavelength range of the light emitted from the light source.

Still another aspect of the present invention is directed to a shape estimation method of estimating a curved shape of a flexible structure. The shape estimation method includes: supplying light to a light guide incorporated in the flexible structure, the light guide having a detection target configured to change a light quantity of the light guided by the light guide according to the curved state of the light guide; detecting the light quantity that has been changed by the detection target by a light detector including a light receiving element including a part that the light does not enter; and calculating information related to the curve of the light guide in which an error of the light detector caused by noise containing dark current of the light detector is corrected based on an output of the part of the light receiving element that the light does not enter.

Advantages of the invention will be set forth in the description that follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a configuration example of a shape estimation apparatus according to the first embodiment.

FIG. 2 shows a cross-sectional view of the detection target along a plane perpendicular to the axis of a light guide.

FIG. 3 shows an example of a relationship between wavelength and absorptivity of light of a first light absorber, a second light absorber, and an n-th light absorber.

FIG. 4A schematically shows the transmission of light when a light guide is curved such that the detection target comes inside a curve of the light guide.

FIG. 4B schematically shows the transmission of light when the light guide is not curved.

FIG. 4C schematically shows the transmission of light when a light guide is curved such that the detection target comes outside the curve of the light guide.

FIG. 5 shows the relationship between dark current and temperature.

FIG. 6 shows the relationship between the dark current and the wavelength when the temperature is high, and the relationship between the dark current and the wavelength when the temperature is low.

FIG. 7 shows the relationship between thermal noise and wavelength when the temperature is high, and the relationship between the thermal noise and the wavelength when the temperature is low.

FIG. 8 shows an example of the relationship between the wavelength of light incident on a light detector and detection sensitivity of the light detector.

FIG. 9 schematically shows another configuration example of the shape estimation apparatus according to the first embodiment.

FIG. 10 shows the processor and its periphery in the first embodiment.

FIG. 11A shows a part of a flowchart of shape estimation in the first embodiment.

FIG. 11B shows a remaining part of the flowchart of shape estimation in the first embodiment.

FIG. 12 is a configuration drawing of a shape estimation apparatus according to a second embodiment.

FIG. 13 shows a processor and its periphery in the second embodiment.

FIG. 14 shows an example of sequence control for controlling opening and closing of shutters shown in FIG. 12 and FIG. 13.

FIG. 15A shows a part of a flowchart of shape estimation in the second embodiment.

FIG. 15B shows a remaining part of the flowchart of shape estimation in the second embodiment.

FIG. 16 is a configuration drawing of a shape estimation apparatus according to a third embodiment.

FIG. 17 shows a processor and its periphery in the third embodiment.

FIG. 18 shows an example of sequence control for controlling on/off of a light source shown in FIG. 16 and FIG. 17.

FIG. 19A shows a part of a flowchart of shape estimation in the third embodiment.

FIG. 19B shows a remaining part of the flowchart of shape estimation in the third embodiment.

FIG. 20 shows a processor and its periphery in a fourth embodiment.

FIG. 21 shows a relationship between detection information from the light detector and wavelength range of light emitted from the light source in the fourth embodiment.

FIG. 22 shows a partial configuration of a light detector according to a modification of the fourth embodiment.

FIG. 23A shows a part of the flowchart of shape estimation in the fourth embodiment.

FIG. 23B shows a remaining part of the flowchart of shape estimation in the fourth embodiment.

FIG. 24 is a configuration drawing of a shape estimation apparatus according to a fifth embodiment.

FIG. 25 shows an endoscope apparatus in which the shape estimation apparatus according to the fifth embodiment is incorporated.

FIG. 26 shows a processor and its periphery in the fifth embodiment.

FIG. 27A shows a part of the flowchart of shape estimation in the fifth embodiment.

FIG. 27B shows a remaining part of the flowchart of shape estimation in the fifth embodiment.

### DETAILED DESCRIPTION OF THE INVENTION

<First Embodiment>

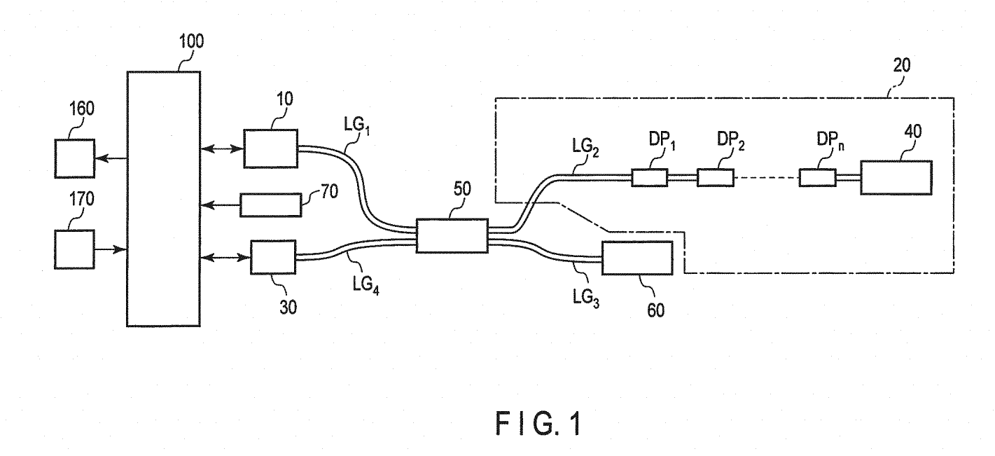

FIG. 1 is a configuration drawing of a shape estimation apparatus according to a first embodiment. The shape estimation apparatus includes: a shape estimation sensor 20 incorporated in a flexible structure, which is an object to be estimated for a curved shape; a light source 10 configured to supply light to the shape estimation sensor 20; a light detector 30 configured to detect light having passed through the shape estimation sensor 20; a light branching unit 50 configured to guide the light from the light source 10 to the shape estimation sensor 20 aid guides the light from the shape estimation sensor 20 to the light detector 30; an anti-reflection member 60 connected to the light branching unit 50; a temperature measuring device 70 configured to measure the temperature in the periphery of the light detector 30; and a processor 100 configured to estimate a shape of the shape estimation sensor 20.

The shape estimation sensor 20 includes a light guide LG₂ connected to the light branching unit 50; detection targets (a first detection target DP₁, a second detection target DP₂, . . . , n-th detection target DPₙ) provided in the light guide LG₂; and a reflection member 40 provided at the end of the light guide LG₂. In the following, the first detection target DP₁, the second detection target DP₂, . . . , the n-th detection target DPₙ are simply expressed as detection targets DPᵢ (i=1, 2, . . . , n).

Each detection target DP₁ is formed of a substance that reduces the light quantity of the light guided by the light guide LG₂. The detection targets DPᵢ each have a function of reducing light having different wavelengths. Each detection target DPᵢ is formed of a light absorber of which light absorptivity with respect to the light passing therethrough changes, for example, according to the curved state of the light guide LG₂, that is, the direction of the curve and the curvature. The light absorber may be formed, for example, of an optical property varying member made of metal particles. The light guide LG₂ is formed of an optical fiber and has flexibility. The shape estimation sensor 20 is formed of a fiber sensor having an optical fiber provided with the detection targets DPᵢ.

The reflection member 40 has a function of reflecting light guided from the light branching unit 50 by the light guide LG₂ back toward the light branching unit 50.

The light source 10 is optically connected to the light branching unit 50 through a light guide LG₁. The light detector 30 is optically connected to the light branching unit 50 through a light guide LG₄. The anti-reflection member 60 is optically connected to the light branching unit 50 through a light guide LG₃. The light guides LG₁, LG₃, and LG₄ are made of, for example, an optical fiber and have flexibility.

The light source 10 has a function of supplying light to the shape estimation sensor 20. The light source 10 includes, for example, a generally known light emitting element such as a lamp, an LED, and a laser diode. The light source 10 may further include a phosphor or the like for converting the wavelength.

The light branching unit 50 guides the light from the light source 10 to the shape estimation sensor 20 and guides the light from the shape estimation sensor 20 to the light detector 30. The light branching unit 50 includes an optical coupler, a half mirror, and the like. For example, the light branching unit 50 divides light emitted from the light source 10 and entered through the light guide LG₁ and guides the light to the two light guides LG₂ and LG₃. The light branching unit 50 also guides the reflected light from the reflection member 40 entered through the light guide LG₂ to the light detector 30 through the light guide LG₄.

The light detector 30 has a function of detecting light that has passed through the shape estimation sensor 20. The light detector 30 has a function of detecting the light quantity of received light for each wavelength, that is, a function of spectrally detecting. The light detector 30 has, for example, an element for spectroscopy such as a spectroscope, a color filter, or a grating, and a light receiving element such as a photodiode or a linear image sensor. The light receiving element has a function of converting light incident on a light receiver or a pixel into an electric signal, that is, a function as a photoelectric conversion element, and the magnitude of the electric signal reflects the quantity of incident light. The light detector 30 detects the light quantity in a predetermined wavelength range, and then outputs detection information. Here, the detection information is information representing the relationship between a specific wavelength in a predetermined wavelength range and the light quantity of the light of that wavelength.

The anti-reflection member 60 has a function of preventing light not entering the light guide LG₂ among the light emitted from the light source 10 from returning to the light detector 30.

The temperature measuring device 70 has a function of measuring the temperature in the periphery of the light detector 30. The temperature measuring device 70 may be formed of, for example, a thermocouple, a resistance thermometer, or the like. Also, although the temperature measuring device 70 is illustrated in FIG. 1 as a separate element from the light detector 30, it is not limited thereto and may be formed of an IC chip capable of measuring the temperature mounted on the light detector 30.

A display 160 configured to display the curved shape of a flexible structure in which the shape estimation apparatus is incorporated, and an input device 170 configured to input various information necessary for estimating the curved shape of the structure are connected to the processor 100.

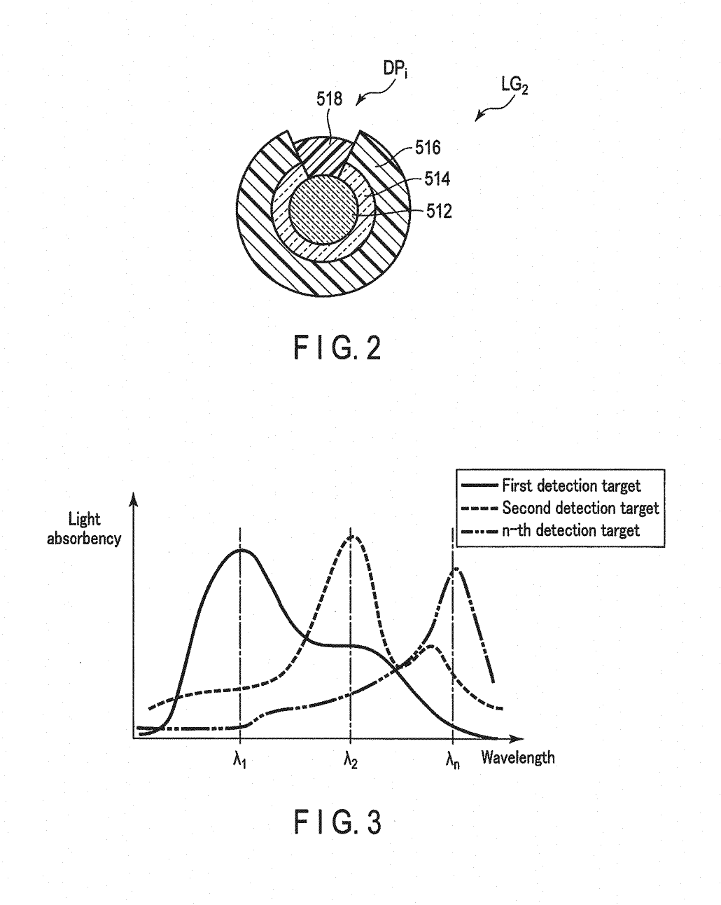

FIG. 2 shows a cross-sectional view of the detection target DPᵢ along a plane perpendicular to an axis of the light guide LG₂. The light guide LG₂ has a core 512, a cladding 514 surrounding the core 512, and a jacket 516 surrounding the cladding 514.

The detection target DPᵢ is formed by applying a light absorber 518 on the core 512 exposed by removing a part of the jacket 516 of the light guide LG₂ and a part of the cladding 514. The light absorbers 518 of the detection targets DPᵢ have different light absorptivity for each wavelength. In other words, the light absorbers 518 of the detection targets DPᵢ are formed by applying light absorbers having different light absorptivity. The member utilized for detection target DPᵢ is not limited to a light absorber. An optical member that affects the spectrum of guided light may be used. Such an optical member may be, for example, a wavelength conversion member (phosphor).

FIG. 3 shows an example of the relationship between the wavelength of light and the absorptivity in the first detection target DP₁, the second detection target DP₂, and the n-th detection target DPₙ. In FIG. 3, a solid line indicates the light absorption characteristic of the first detection target DP₁, a broken line indicates the light absorption characteristic of the second detection target DP₂, and a two-dot chain line indicates the light absorption characteristic of the n-th detection target DPₙ. As shown in FIG. 3, different detection targets DPᵢ have different light absorption characteristics.

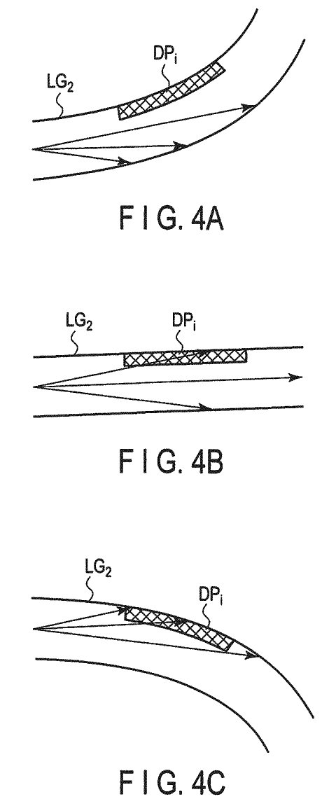

Detection light guided by the light guide LG₂ is lost at the detection target DPᵢ. The quantity of light guide loss changes according to the direction and amount of curve of the light guide LG₂, as shown in FIGS. 4A to 4C.

For example, as shown in FIG. 4A, when the light guide LG₂ is curved such that the detection target DPᵢ comes inside the curve of the light guide LG₂, the quantity of light guide loss is smaller than in the case where the light guide LG₂ is not curved as shown in FIG. 4B. Further, the quantity of light guide loss decreases in proportion the amount of curving of the light guide LG₂, that is, the curvature.

In contrast, as shown in FIG. 4C, when the light guide LG₂ is curved such that the detection target DPᵢ comes outside the curve of the light guide LG₂, the quantity of light guide loss is larger than in the case where the light guide LG₂ is not curved as shown in FIG. 4B. In addition, the quantity of light guide loss increases in proportion to the amount of curving, that is, the curvature, of the light guide LG₂.

A change in the quantity of light guide loss is reflected in the amount of detection light received by the light detector 30. That is, it is reflected in the detection information from the light detector 30. Therefore, by monitoring the detection information from the light detector 30, it is possible to grasp the direction and amount of curve of the light guide LG₂.

That is, the shape estimation sensor 20 is configured such that the light quantity detected for the wavelength corresponding to each of the detection targets DPᵢ differs according to the shape of each of the detection targets DPᵢ.

In FIG. 1, light emitted from the light source 10 is guided by the light guide LG₁ and then enters the light branching unit 50. The light branching unit 50 divides and outputs the entered light to the two light guides LG₂ and LG₃.

The light guided by the light guide LG₃ is absorbed, for example, by the anti-reflection member 60 provided at the end of the light guide LG₃.

The light guided by the light guide LG₂ is reflected by the reflection member 40 provided at the end of the light guide LG₂, and is again guided by the light guide LG₂ to return to the light branching unit 50. The wavelength component of the light guided by the light guide LG₂ corresponding to the detection target DPᵢ is lost by the detection target DPᵢ while being guided.

The light branching unit 50 divides the returned light and outputs a part of the light to the light guide LG₄. The light output to the light guide LG₄ is guided by the light guide LG₄ and then enters the light detector 30. The light received by the light detector 30 is light that has passed through the detection target DPᵢ, and changes depending on the curvature of the detection target DPᵢ.

The temperature measuring device 70 measures the temperature in the periphery of the light detector 30, and then outputs the measured temperature information to the processor 100.

The processor 100 estimates the shape of the light guide LG₂ of the shape estimation sensor 20 based on the detection information from the light detector 30 and the temperature information from the temperature measuring device 70.

As described above, the detection information from the light detector 30 changes depending on the curvature of the detection target DPᵢ. However, the detection information from the light detector 30 changes due to noise such as dark current and thermal noise in addition to the curvature of the detection target DPᵢ.

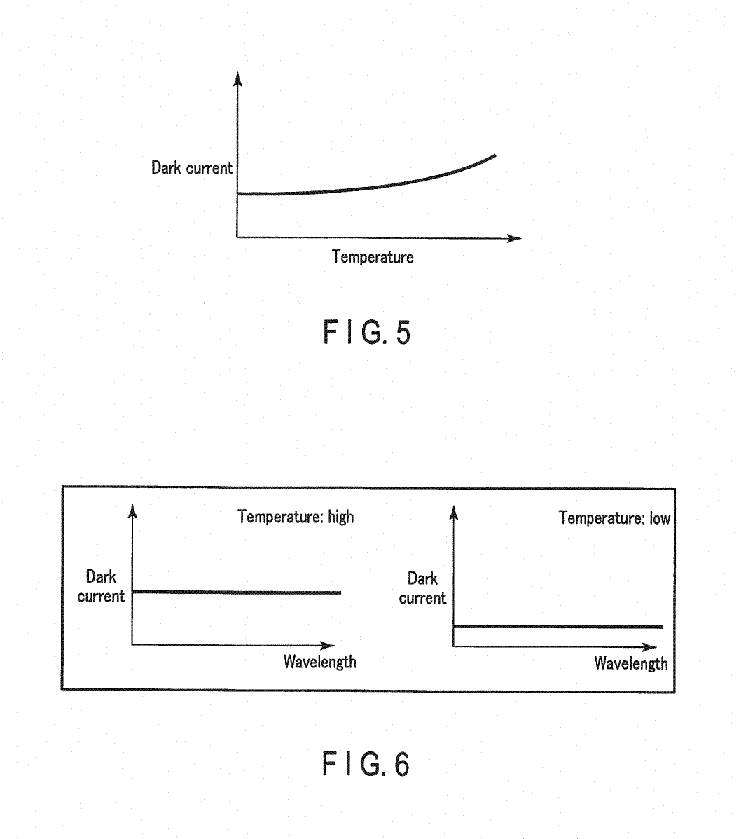

Describing briefly about the dark current, dark current is a signal output from the light detector 30 in a state in which no light enters the light detector 30. Dark current has the property of increasing as the temperature rises. FIG. 5 shows the relationship between dark current and temperature. As can be seen from FIG. 5, the magnitude of dark current at high temperatures is greater than the magnitude of dark current at low temperatures.

In addition, dark current changes in magnitude depending on temperature, but does not change depending on wavelength. FIG. 6 shows the relationship between the dark current and the wavelength when the temperature is high, and the relationship between the dark current and the wavelength when the temperature is low.

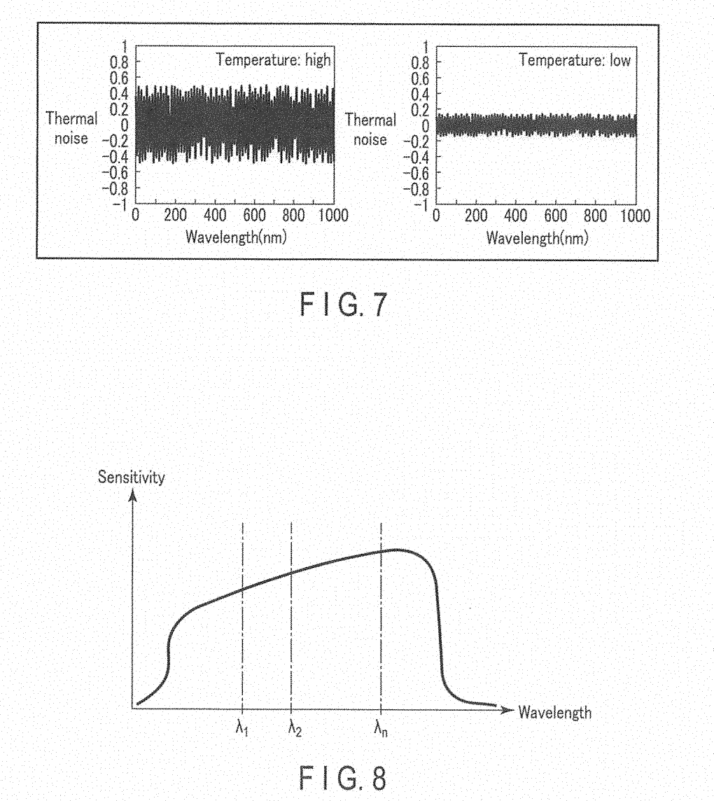

In addition to dark current, the output signal from the light detector 30 contains thermal noise. The thermal noise is white noise of the same power spectral density in any wavelength band. The magnitude of the thermal noise amplitude has the property of increasing as the temperature rises. FIG. 7 shows the relationship between thermal noise and wavelength when the temperature is high, and the relationship between the thermal noise and the wavelength when the temperature is low.

FIG. 8 shows an example of the relationship between the wavelength of light incident on a light detector 30 and detection sensitivity of the light detector 30. The light detector 30 has detection sensitivity in a wavelength range including the first wavelength λ₁, the second wavelengths λ₂, . . . , and the n-th wavelength λₙ. The light detector 30 outputs, to the processor 100, detection information representing the light quantities of, for example, the wavelengths λ₁, λ₂, . . . , λₙ.

The waveform of the spectrum of sensitivity to the wavelength of the light detector 30 shown in FIG. 8 is very important for the calculation of the curvature of the detection target. When dark current and/or thermal noise is added to the output signal from the light detector 30, the waveform of the spectrum of sensitivity to the wavelength of the light detector 30 wavelength is disturbed. The disturbance of waveform of this spectrum reduces the accuracy of the calculation of the curvature of the detection target DPᵢ.

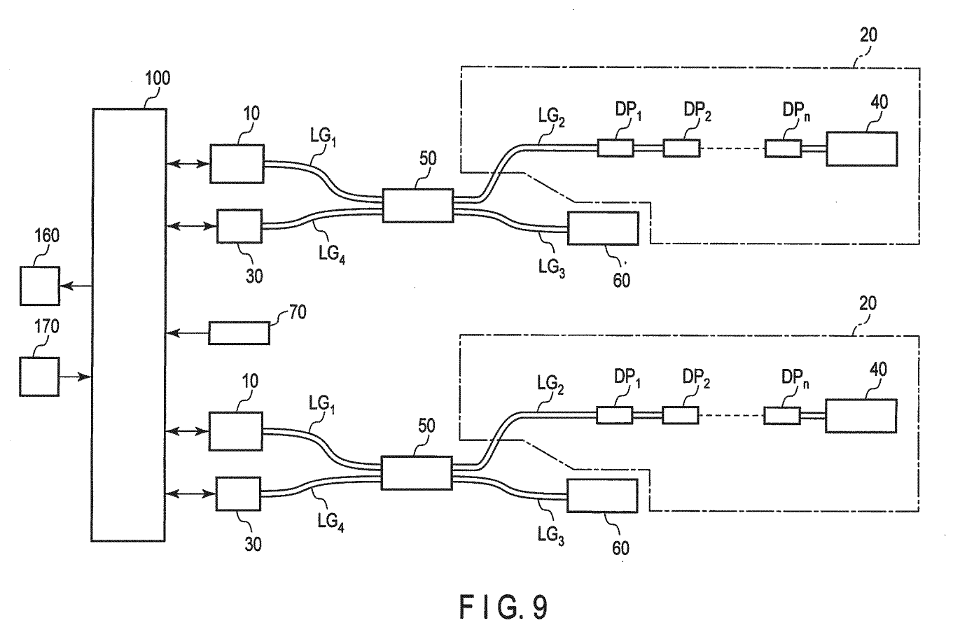

Although a shape estimation apparatus having one system of shape estimation sensor 20 is illustrated in FIG. 1, the present embodiment is not limited thereto, and as illustrated in FIG. 9, the shape estimation apparatus may have systems, for example, two systems of the shape estimation sensor 20.

[Arithmetic Processing Unit (Processor and its Periphery)]

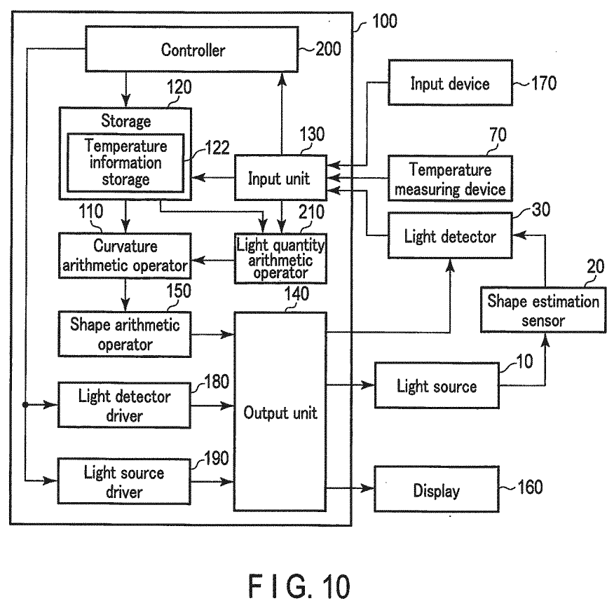

Subsequently, an arithmetic processing unit configured to estimate the shape of the shape estimation sensor 20 will be described. FIG. 10 shows the processor 100 and its periphery in the present embodiment. The processor 100 may be formed of an electronic computer, for example, a personal computer.

The processor 100 includes an input unit 130, a controller 200, a storage 120, a light quantity arithmetic operator 210, a curvature arithmetic operator 110, a shape arithmetic operator 150, a light detector driver 180, a light source driver 190, and an output unit 140.

The input unit 130 is configured to receive an input of detection information that is the relationship between the wavelength and the light quantity acquired by the light detector 30 using the shape estimation sensor 20. Here, the detection information that is the relationship between the wavelength and the light quantity is, for example, a spectrum having different light absorptivity.

The input unit 130 is also configured to receive an input of information on the temperature in the periphery of the light detector 30. For example, the input unit 130 is configured to receive an input of information on the temperature acquired by the temperature measuring device 70.

The input unit 130 is further configured to receive an input of a shape estimation start signal, a shape estimation end signal, a signal regarding setting of the curvature arithmetic operator 110, a signal regarding setting of the shape arithmetic operator 150, and the like from the input device 170.

The controller 200 controls the setting of the light quantity intensity of the light emitting element of the light source 10 through the light source driver 190 according to the signal from the input device 170.

The storage 120 stores light quantity estimation relationships including shape characteristic information indicating the relationship between the shape, the wavelength, and the light quantity for each of the detection targets DPᵢ. The storage 120 also stores various items of information necessary for the operation performed by the shape arithmetic operator 150, such as information on the position of each of the detection targets DPᵢ. The storage 120 further stores, for example, a program including a calculation algorithm.

The storage 120 includes a temperature information storage 122 storing information on the dark current of the light detector 30 according to the temperature.

The light quantity arithmetic operator 210 acquires, from the temperature information storage 122, information on dark current according to the temperature information from the temperature measuring device 70. The information on dark current is, for example, a dark current value indicating the magnitude of the dark current. The dark current value of the light detector 30 may be determined from MAP based on temperature information or an equation using temperature as a variable. The light quantity arithmetic operator 210 calculates light quantity information by subtracting the dark current value from the detection information from the light detector 30.

In addition, in order to reduce the white noise of the thermal noise, the light quantity arithmetic operator 210 determines the number of times (m) of averaging the light quantity information according to the temperature information from the temperature measuring device 70 and calculates average light quantity information by averaging the light quantity information with the number of times (m). The averaging may be averaging of time-series data of light quantity information or averaging of adjacent pixels of light quantity information. Here, averaging of time-series data of light quantity information means a process of dividing time integration of light quantity data acquired time-sequentially at a predetermined exposure time by the number of times of acquisition. Further, averaging of the adjacent pixels of the light quantity information means a process of averaging the light quantity data detected by a pixel that senses light having a wavelength corresponding to each detection target DPᵢ and pixels in the periphery thereof in a linear image sensor that detects light after dispersion in the light detector 30. In other words, the averaging of the adjacent pixels of the light quantity information means a process of averaging the light quantity data of the light having a wavelength corresponding to each detection target DPᵢ and the light having peripheral wavelengths. Alternatively, instead of averaging the light quantity information, noise may be reduced by setting the exposure time longer to increase the time integration of the light quantity data.

As described above, the light quantity arithmetic operator 210 has a function of correcting an error caused by dark current value and thermal noise with respect to the detection information from the light detector 30. The light quantity arithmetic operator 210 transmits average light quantity information, which is the light quantity information thus corrected, to the curvature arithmetic operator 110.

The curvature arithmetic operator 110 reads the light quantity estimation relationship from the storage 120, and then calculates an estimated light quantity value that is a relationship between the wavelength corresponding to each detection target DPᵢ and the light quantity based on the light quantity estimation relationship. The curvature arithmetic operator 110 further calculates the curvature of each of the detection targets DPᵢ based on the estimated light quantity value calculated based on the light quantity estimation relationship read from the storage 120 and the average light quantity information supplied from the light quantity arithmetic operator 210. The curvature arithmetic operator 110 outputs the calculated curvatures of the detection targets DPᵢ to the shape arithmetic operator 150.

The shape arithmetic operator 150 reads the information on the position of each detection target DPᵢ from the storage 120 and then calculates the shape information of the light guide LG₂ provided with the detection targets DPᵢ based on the curvature of each detection target DPᵢ supplied from the curvature arithmetic operator 110 and the information on the read position. The shape arithmetic operator 150 outputs the calculated shape information of the light guide LG₂ to the output unit 140 as a curved shape of a flexible structure in which the shape estimation sensor 20 including the light guide LG₂ is incorporated.

The light detector driver 180 generates a drive signal of the light detector 30 based on the information acquired from the input unit 130 or the shape arithmetic operator 150, and then transmits the generated drive signal to the output unit 140. The drive signal of the light detector 30 is a signal for performing on/off switching of the light detector 30 and gain adjustment of the light detector 30.

The light source driver 190 generates a drive signal of the light source 10, and then transmits the generated drive signal to the output unit 140.

The output unit 140 outputs the shape information of the light guide LG₂ acquired from the shape arithmetic operator 150 to the display 160. The output unit 140 also transmits a drive signal from the light source driver 190 to the light source 10. The output unit 140 transmits the drive signal from the light detector driver 180 to the light detector 30.

[Flowchart of Shape Estimation]

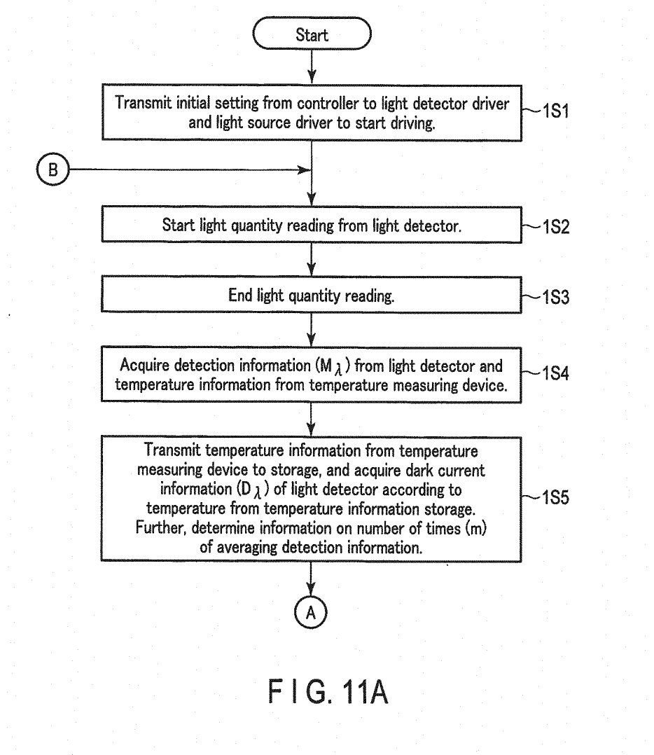

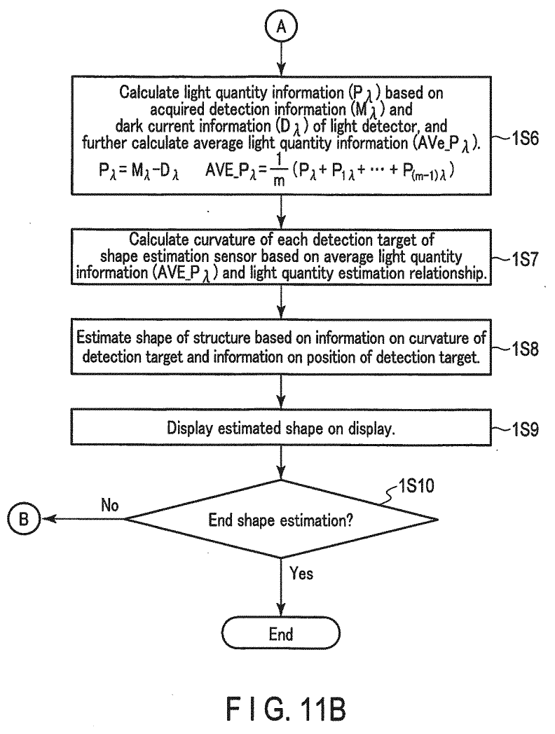

FIGS. 11A and 11B show flowcharts of the shape estimation operation in the present embodiment.

In step 1S1, in response to the shape estimation start signal from the input device 170, the controller 200 transmits initial settings to the light detector driver 180 and the light source driver 190 to start driving of the light detector 30 and the light source 10.

Accordingly, in step 1S2, the light quantity reading from the light detector 30 is started.

In step 1S3, the light detector 30 ends the light quantity reading, and then outputs light quantity reading end signal.

Here, from the start of light quantity reading in step 1S2 to the end of the light quantity reading in step 1S3, light quantity signals of all wavelengths (for example, light quantity signals corresponding to wavelengths 0 to 1000 nm in FIG. 7) is sent serially to the light detector 30 at once.

In accordance with the light quantity reading end signal, in step 1S4, the detection information (M_{λ}) from the light detector 30 and the temperature information from the temperature measuring device 70 are acquired.

In step 1S5, the temperature information from the temperature measuring device 70 is transmitted to the storage 120, and the dark current information (D_{λ}) of the light detector 30 according to the temperature is acquired from the temperature information rage 122. Further, information of the number of times (m) of averaging the detection information from the light detector 30 is determined.

In step 1S6, light quantity information (P_{λ}) is calculated based on the acquired detection information (M_{λ}) from the light detector 30 and the dark current information (D_{λ}) of the light detector 30, and then stored in the storage 120. The light quantity information (P_{λ}) is calculated according to the following equation (1).

P_{λ}=M_{λ}−D_{λ} (1)

Further, average light quantity information (AVE_P_{λ}) is calculated. The average light quantity information (AVE_P_{λ}) is calculated according to the following equation (2). Here, P_{jλ} (j=1, 2, . . . , m−1) means light quantity information (P_{λ}) acquired before j samples, and is read from the storage 120 and used.

$${AVE\_P}_{λ} = \frac{1}{m} ( {P}_{λ} + {P}_{1 λ} + … + {P}_{( m - 1 ) λ} ) \qquad ( 2 )$$

Since the light quantity information (P_{λ}) is calculated by subtracting the dark current information (D_{λ}) from the detection information (M_{λ}), the influence of the dark current information (D_{λ}) due to the temperature is removed from the light quantity information (P_{λ}). Further, since the average light quantity information (AVE_P_{λ}) is calculated by averaging the light quantity information (P_{λ}), the influence of the thermal noise information (Th) due to the temperature is reduced from the average light quantity information (AVE_P_{λ}). The calculation of average light quantity information cannot be performed until m pieces of light quantity information are obtained, and the following steps 1S7 to 1S9 are skipped. Alternatively, the average light quantity information may be calculated from pieces of currently acquired light quantity information although the pieces of light quantity information is equal to or less than m.

In step 1S7, the curvature of each detection target DPᵢ of the shape estimation sensor 20 is calculated based on the average light quantity information (AVE_P_{λ}) and the light quantity estimation relationship acquired from the storage 120.

In step 1S8, the shape of the light guide LG₂ of the shape estimation sensor 20, that is, the shape of the structure in which the shape estimation sensor 20 is incorporated, is estimated based on the information on the curvature of each detection target DPᵢ and the information on the position of each detection target DPᵢ acquired from the storage 120.

In step 1S9, the estimated shape of the light guide LG₂, that is, the structure is displayed on the display 160.

In step 1S10, it is determined whether or not to finish the shape estimation. Specifically, it is determined whether the shape estimation end signal from the input device 170 has been received. If the determination result is “No”, the process returns to step 1S2. If the judgment result “Yes”, shape estimation is ended.

The shape estimation apparatus according to the present embodiment removes the influence of noise (dark current and thermal noise) from the detection information acquired from the light detector 30, so that calculation of the curvature of each of the detection targets DPᵢ of the shape estimation sensor 20 and estimation of the shape of the light guide LG₂ can be performed with high accuracy. Accordingly, the shape of the flexible structure in which the shape estimation sensor 20 is incorporated can be estimated with high accuracy. As a result, a shape estimation apparatus configured to estimate an accurate shape free of errors due to temperature-dependent noise is provided.

<Second Embodiment>

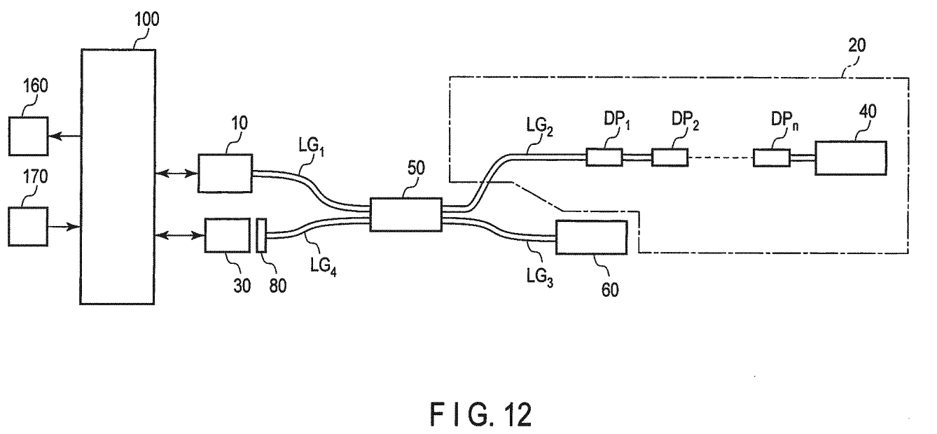

FIG. 12 is a configuration drawing of a shape estimation apparatus according to a second embodiment. In FIG. 12, members denoted with the same reference signs as the members shown in FIG. 1 are the same members, and the detailed description thereof will be omitted. Hereinafter, the second embodiment will be described focusing on differences from the first embodiment.

The shape estimation apparatus of the present embodiment is different from the shape estimation apparatus of the first embodiment in the following two points. The first difference is that the shape estimation apparatus of the first embodiment has the temperature measuring device 70, while the shape estimation apparatus of the present embodiment does not have the temperature measuring device 70. The second difference is that the shape estimation apparatus of the present embodiment has a shutter 80 disposed between the light detector 30 and the light guide LG₄. The shutter 80 has a function of blocking light that enters the light detector 30 from the light guide LG₄ when necessary.

In the configuration shown in FIG. 12, the shutter 80 is disposed between the light detector 30 and the light guide LG₄, but the installation location of the shutter 80 is not limited thereto. The shutter 80 may be disposed anywhere on the optical path from the light source 10 to the light detector 30 as long as it can block light that enters the light detector 30 as needed.

[Arithmetic Processing Unit (Processor and its Periphery)]

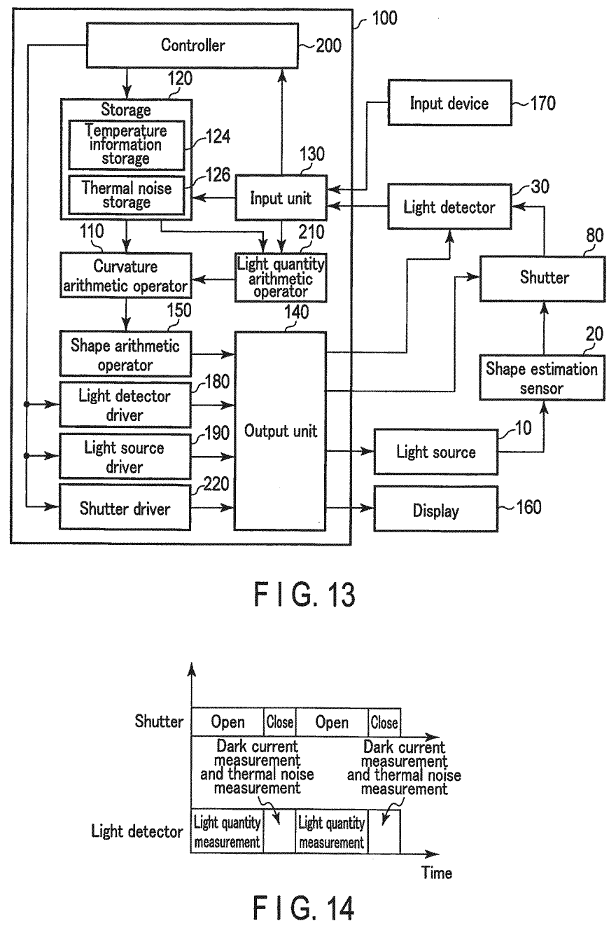

Then, the arithmetic processing unit of the shape estimation apparatus of the present embodiment is described. FIG. 13 shows the processor 100 and its periphery in the present embodiment. The configuration of the processor 100 in the present embodiment is basically the same as the processor 100 in the first embodiment. The differences will be described below.

The processor 100 of the present embodiment includes a shutter driver 220 in addition to the respective elements of the processor 100 of the first embodiment. The shutter driver 220 transmits a shutter open/close signal to the output unit 140. The shutter open signal is a signal that causes the shutter 80 to open, and the shutter close signal is a signal that causes the shutter 80 to close. The output unit 140 transmits a shutter open/close signal from the shutter driver 220 to the shutter 80. The shutter 80 opens and closes in response to the shutter open/close signal.

Further, the storage 120 of the present embodiment does not have the temperature information storage 122 of the first embodiment, but instead, a dark current storage 124 configured to store dark current information, and a thermal noise storage 126 configured to store thermal noise information.

The controller 200 causes the shutter driver 220 to transmit a shutter open/close signal to the shutter 80 through the output unit 140. The shutter 80 opens and closes in response to the shutter open/close signal. Opening and closing of the shutter 80 is performed in accordance with preset sequence control. FIG. 14 shows an example of sequence control. The shutter 80 repeats opening and closing according to the sequence control.

During the shutter 80 is open, light emitted from the light source 10, passing through the shape estimation sensor 20, and directed to the light detector 30 enters the light detector 30 without being blocked by the shutter 80. Therefore, the light detector 30 outputs detection information that changes depending on the curvature of the detection target DPᵢ. That is, during this period, light quantity measurement for shape estimation is performed.

During the shutter 80 is closed, light emitted from the light source 10, passing through the shape estimation sensor 20, and directed to the light detector 30 is blocked by the shutter 80 and thus does not enter the light detector 30. For this reason, the light detector 30 outputs a signal related to noise (dark current and thermal noise). That is, during this period, dark current measurement and thermal noise measurement are performed.

The output signal of the light detector 30 is transmitted to the storage 120 through the input unit 130 and then stored in the storage 120. Detection information from the light detector 30 acquired in a state where the shutter 80 is opened is stored in the storage 120 as detection information (M_{λ}) for shape estimation. Further, the detection information from the light detector 30 obtained in the state where the shutter 80 is closed is stored in the dark current storage 124 as dark current information (D_{λ}) of the light detector 30.

The controller 200 calculates dark current information (D_{λ}) of the light detector 30 by averaging pieces of detection information of the light detector 30 acquired and stored in the storage 120 in a state where the shutter 80 is closed. The controller 200 stores the calculated dark current information (D_{λ}) in the dark current storage 124.

Further, the controller 200 calculates the thermal noise information (Th) of the light detector 30 from the standard deviation or the like of the detection information acquired and stored in the state where the shutter 80 is closed. The controller 200 stores the calculated thermal noise information (Th) of the light detector 30 in the thermal noise storage 126.

The light quantity arithmetic operator 210 determines the number of times (m) of averaging the light quantity information (D_{λ}) that is a difference between detection information (M_{λ}) from the light detector 30 and dark current information (D_{λ}) acquired for shape estimation according to the thermal noise information (Th).

The light quantity arithmetic operator 210 also calculates light quantity information (P_{λ}) based on the detection information (M_{λ}) from the light detector 30 stored in the storage 120 and the dark current information (D_{λ}) stored in the dark current storage 124. The light quantity information (P_{λ}) is calculated as the difference between the detection information (M_{λ}) and the dark current information (D_{λ}) according to the following equation (3).

P_{λ}=M_{λ}−D_{λ} (3)

The light quantity arithmetic operator 210 further calculates average light quantity information (AVE_P_{λ}). The average light quantity information (AVE_P_{λ}) is calculated by averaging the light quantity information by the number of times (m) of averaging determined according to the thermal noise information (Th) stored in the thermal noise storage 126 according to the following equation (4). The averaging may be either averaging of time-series data of light quantity information or averaging of adjacent pixels of light quantity information, as in the first embodiment.

$${AVE\_P}_{λ} = \frac{1}{m} ( {P}_{λ} + {P}_{1 λ} + … + {P}_{( m - 1 ) λ} ) \qquad ( 4 )$$

The curvature arithmetic operator 110 calculates curvatures characteristic information Rᵢ (i=1, 2, . . . , n) of the detection targets DPᵢ according to the following equation (5) based on the average light quantity information (AVE_P_{λ}) from the light quantity arithmetic operator 210 and the light quantity estimation relationship stored in the storage 120. Specifically, the curvature characteristic information Rᵢ of each detection target is calculated from an equation including the absorbance (Uᵢ) of each detection target, the linear light quantity information (ST), and the average light quantity information (AVE_P_{λ}). Here, R₁ represents the curvature characteristic information of the first detection target DP₁, R₂ represents the curvature characteristic information of the second detection target DP₂, . . . , and Rₙ represents the curvature characteristic information of the n-th detection target DPₙ. The curvature arithmetic operator 110 outputs the calculated curvature characteristic information Rᵢ of each of the detection targets DPᵢ to the shape arithmetic operator 150.

$$\begin{matrix}{R}_{i} = f ( {AVE\_P}_{λ} ) \\ = {U}_{i}^{- 1} \times log ( {AVE\_P}_{λ} / ST )\end{matrix} \\ i = 1 , 2 , … , n \qquad ( 5 )$$

The shape arithmetic operator 150 calculates shape information of the light guide LG₂ provided with detection targets DPᵢ based on the curvature of each detection target DPᵢ and the information of the position stored in the storage 120. The shape arithmetic operator 150 transmits the shape information of the light guide LG₂ to the display 160 through the output unit 140.

The display 160 displays the shape information of the light guide LG₂ as a curved shape of a flexible structure in which the shape estimation sensor 20 including the light guide LG₂ is incorporated.

[Flowchart of Shape Estimation]

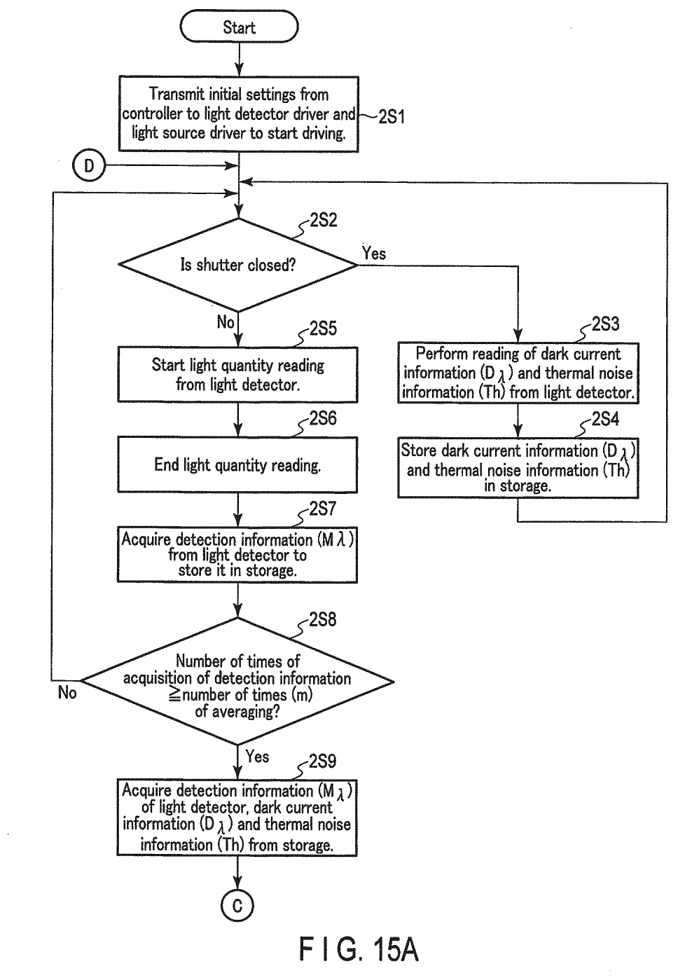

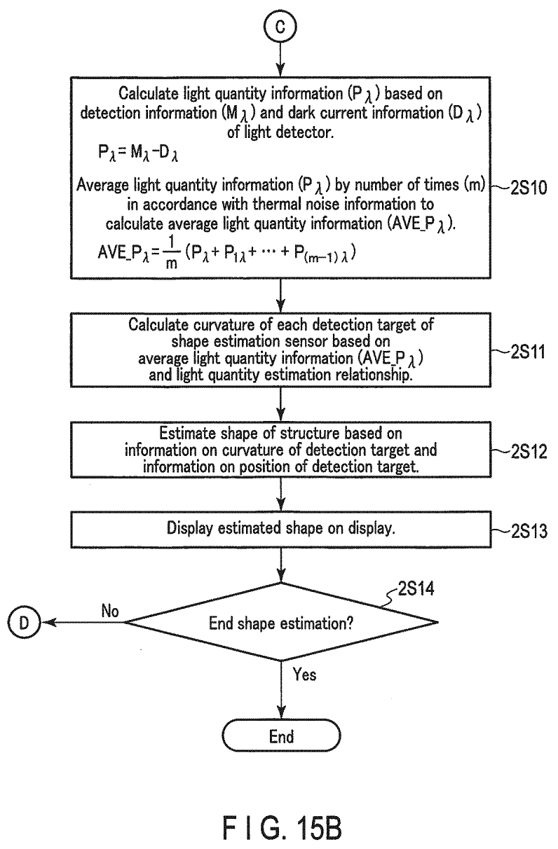

FIGS. 15A and 15B show a flowchart of the shape estimation operation in the present embodiment.

In step 2S1, in response to the shape estimation start signal from the input device 170, the controller 200 transmits initial settings to the light detector driver 180 and the light source driver 190 to start driving the light detector 30 and the light source 10. The shutter 80 is repeatedly opened and closed based on sequence control. At the start of this, first, the shutter 80 is closed from the shutter driver 220 through the output unit 140.

In step 2S2, it is determined whether the shutter 80 is closed. Specifically, it is determined whether the shutter open/close signal transmitted from the shutter driver 220 to the shutter 80 through the output unit 140 is a shutter close signal. If the judgment result is “Yes”, dark current measurement and thermal noise measurement are performed. In contrast, when the judgment result is “No”, light quantity measurement for shape estimation is performed.

If the determination result in step 2S2 is “Yes”, in step 2S3, the dark current information (D_{λ}) and the thermal noise information (Th) from the light detector 30 are read. This means performing light quantity reading with the light detector 30 in the same manner as in steps 2S5 and 2S6 and reading the detection information of the light detector 30 as dark current information (D_{λ}). If dark current information (D_{λ}) is read some times, the average is taken as the current dark current information (D_{λ}). Further, the thermal noise information (Th) is calculated from the standard deviation or the like of pieces of detection information.

Subsequently, in step 2S4, the dark current information (D_{λ}) and the thermal noise information (Th) of the light detector 30 are stored in the storage 120. Thereafter, the process returns to step 2S2. At this time, a shutter open signal is transmitted from the shutter driver 220 to the shutter 80 through the output unit 140 to open the shutter 80.

If the result of the determination in step 2S2 is “No”, the light quantity reading from the light detector 30 is started in step 2S5.

In step 2S6, the light detector 30 ends the light quantity reading, and then outputs a light quantity reading end signal.

In accordance with the light quantity reading end signal, detection information (M_{λ}) from the light detector 30 is acquired in step 2S7. Furthermore, the acquired detection information (M_{λ}) is stored in the storage 120. At this time, a shutter close signal is transmitted from the shutter driver 220 to the shutter 80 through the output unit 140 to close the shutter 80.

In step 2S8, the number of times (m) of averaging the light quantity information (P_{λ}) is determined according to the thermal noise information (Th), and the number of times of acquisition of the detection information (M_{λ}) from the light detector 30 is equal to or more than the number of times (m). If the determination result is “No”, the process returns to step 2S2. If the judgment result is “Yes”, shape estimation is performed.

It the determination result in step 2S8 is “Yes”, in step 2S9, detection information (M_{λ}) from the light detector 30 is acquired from the storage 120, the dark current information (D_{λ}) is acquired from the dark current storage 124, and the thermal noise information (Th) is acquired from the thermal noise storage 126. As described above, the dark current information (D_{λ}) is calculated by averaging pieces of detection information of the light detector 30 acquired when the shutter 80 is closed, and then stored in the dark current storage 124. Further, the thermal noise information (Th) is calculated from the standard deviation or the like of pieces of detection information acquired in a state where the shutter 80 is closed, and then stored in the thermal noise storage 126.

Subsequently, in step 2S10, light quantity information (P_{λ}) is calculated based on the detection information (M_{λ}) from the light detector 30 and the dark current information (D_{λ}). The light quantity information (P_{λ}) is calculated as the difference between the detection information (M_{λ}) and the dark current information (D_{λ}) in accordance with the above-mentioned equation (3).

Further, average light quantity information (AVE_P_{λ}) is calculated. The average light quantity information (AVE_P_{λ}) is calculated according to the above-mentioned equation (4).

In step 2S11, the curvature of each detection target DPᵢ of the shape estimation sensor 20 is calculated based on the average light quantity information (AVE_P_{λ}) and the light quantity estimation relationship acquired from the storage 120.

In step 2S12, the shape of the light guide LG₂ of the shape estimation sensor 20, that is, the shape of the structure in which the shape estimation sensor 20 is incorporated, is estimated based on the information on the curvature of each detection target DPᵢ and the information on the position of each detection target DPᵢ acquired from the storage 120.

In step 2S13, the estimated shape of the light guide LG₂, that is, the structure is displayed on the display 160.

In step 2S14, it is determined whether or not to finish the shape estimation. If the determination result is “No”, the process returns to step 2S2. If the judgment result is “Yes”, shape estimation is ended.

As with the first embodiment, the shape estimation apparatus according to the present embodiment removes the influence of noise (dark current and thermal noise) from the detection information acquired from the light detector 30, so that calculation of the curvature of each of the detection targets DPᵢ of the shape estimation sensor 20 and estimation of the shape of the light guide LG₂ can be performed with high accuracy. Accordingly, the shape of the flexible structure in which the shape estimation sensor 20 is incorporated can be estimated with high accuracy. As a result, a shape estimation apparatus configured to estimate an accurate shape free of errors due to temperature-dependent noise is provided.

<Third Embodiment>

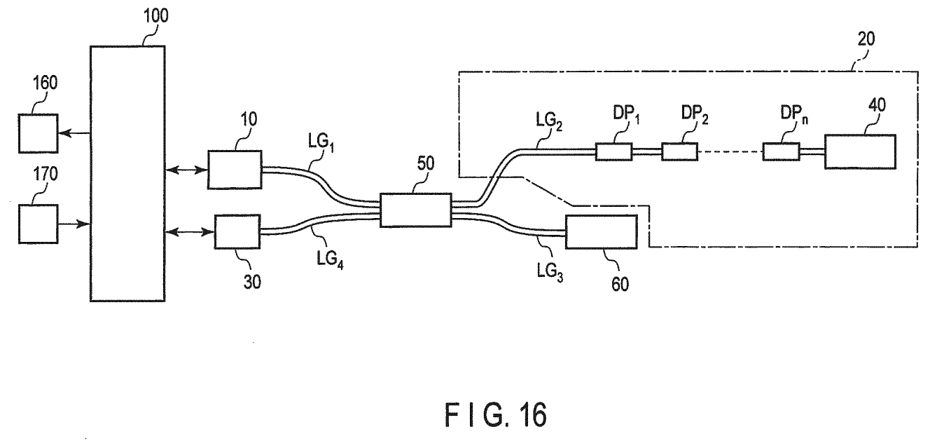

FIG. 16 is a configuration drawing of a shape estimation apparatus according to a third embodiment. In FIG. 16, members denoted with the same reference signs as the members shown in FIG. 1 are the same members, and the detailed description thereof will be omitted. Hereinafter, the third embodiment will be described focusing on differences from the first embodiment.

The shape estimation apparatus of the present embodiment has a hardware configuration in which the temperature measuring device 70 is omitted from the shape estimation apparatus of the first embodiment. The other hardware configuration of the shape estimation apparatus of the present embodiment is the same as the hardware configuration of the shape estimation apparatus of the first embodiment.

[Arithmetic Processing Unit (Processor and its Periphery)]

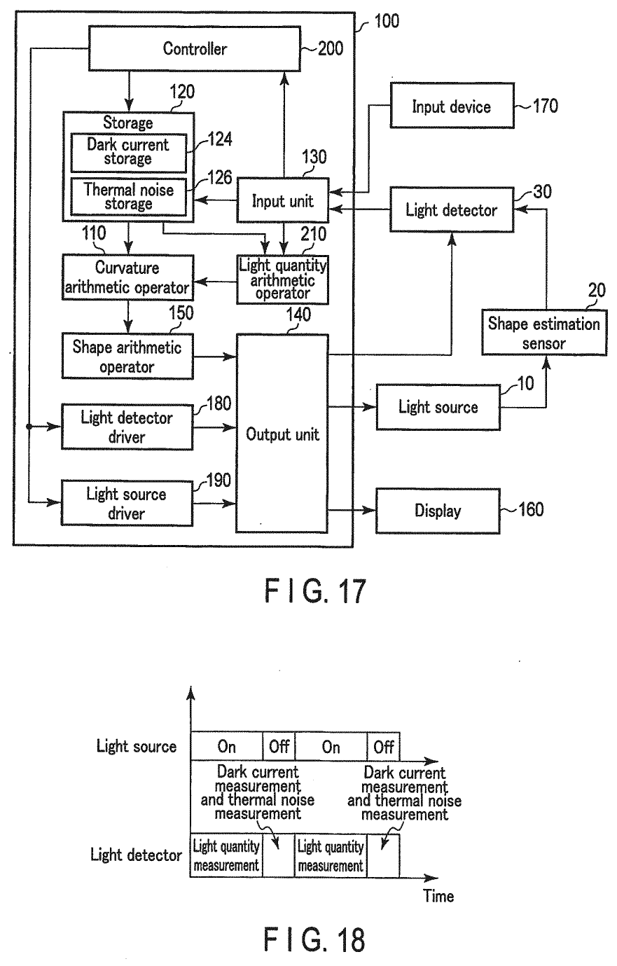

Then, the arithmetic processing unit of the shape estimation apparatus of the present embodiment is described. FIG. 17 shows the processor 100 and its periphery in the present embodiment. The configuration of the processor 100 in the present embodiment is basically the same as the processor 100 in the first embodiment. The differences will be described below.

The storage 120 of the present embodiment does not have the temperature information storage 122 of the first embodiment, but instead, a dark current storage 124 configured to store dark current information, and a thermal noise storage 126 configured to store thermal noise information.

The controller 200 causes the light source driver 190 to transmit a light source on/off signal to the light source 10 through tie output unit 140. The light source 10 turns the light emitting element on and off according to the light source on/off signal. The on/off of the light source 10 is performed according to preset sequence control. FIG. 18 shows an example of sequence control. The light source 10 repeatedly turns on/off according to the sequence control.

While the light source 10 is in the on state, light emitted from the light source 10 passes through the shape estimation sensor 20 and then enters the light detector 30. Therefore, the light detector 30 outputs detection information that changes depending on the curvature of the detection target DPᵢ. That is, during this period, light quantity measurement for shape estimation is performed.

Since the light is not emitted from the light source 10 while the light source 10 is in the off state, the light passing through the shape estimation sensor 20 never enters the light detector 30. For this reason, the light detector 30 outputs a signal related to noise (dark current and thermal noise). That is, during this period, dark current measurement and thermal noise measurement are performed.

The output signal of the light detector 30 is transmitted to the storage 120 through the input unit 130 and then stored in the storage 120. Detection information from the light detector 30 acquired when the light source 10 is in the on state is stored in the storage 120 as detection information (M_{λ}) for shape estimation. Further, detection information from the light detector 30 acquired when the light source 10 is in the off state is stored in the dark current storage 124 as dark current information (D_{λ}) of the light detector 30.

The controller 200 calculates dark current information (D_{λ}) of the light detector 30 by averaging pieces of detection information of the light detector 30 acquired and stored in the storage 120 when the light source 10 is in the off state. The controller 200 stores the calculated dark current information (D_{λ}) in the dark current storage 124.

Further, the controller 200 calculates the thermal noise information (Th) of the light detector 30 from the standard deviation or the like of the detection information acquired and stored when the light source 10 is in the off state. The controller 200 stores the calculated thermal noise information (Th) of the light detector 30 in the thermal noise storage 126.

The light quantity arithmetic operator 210 determines the number of times (m) of averaging the light quantity information (P_{λ}) that is a difference between detection information (M_{λ}) from the light detector 30 and dark current information (D_{λ}) acquired for shape estimation according to the thermal noise information (Th).

The light quantity arithmetic operator 210 also calculates light quantity information (P_{λ}) based on the detection information (M_{λ}) from the light detector 30 stored in the storage 120 and the dark current information (D_{λ}) stored in the dark current storage 124.

The light quantity arithmetic operator 210 further calculates average light quantity information (AVE_P_{λ}). The average light quantity information (AVE_P_{λ}) is calculated by averaging the number of times (m) determined according to the thermal noise information (Th).

The curvature arithmetic operator 110 calculates curvatures of the detection targets DPᵢ based on the average light quantity information (AVE_P_{λ}) from the light quantity arithmetic operator 210 and the light quantity estimation relationship stored in the storage 120. The curvature arithmetic operator 110 outputs the calculated curvatures of the detection targets DPᵢ to the shape arithmetic operator 150.

The shape arithmetic operator 150 calculates shape information of the light guide LG₂ provided with detection targets DPᵢ based on the curvature of each detection target DPᵢ and the information of the position stored in the storage 120. The shape arithmetic operator 150 transmits the shape information of the light guide LG₂ to the display 160 through the output unit 140.

The display 160 displays the shape information of the light guide LG₂ as a curved shape of a flexible structure in which the shape estimation sensor 20 including the light guide LG₂ is incorporated.

[Flowchart of Shape Estimation]

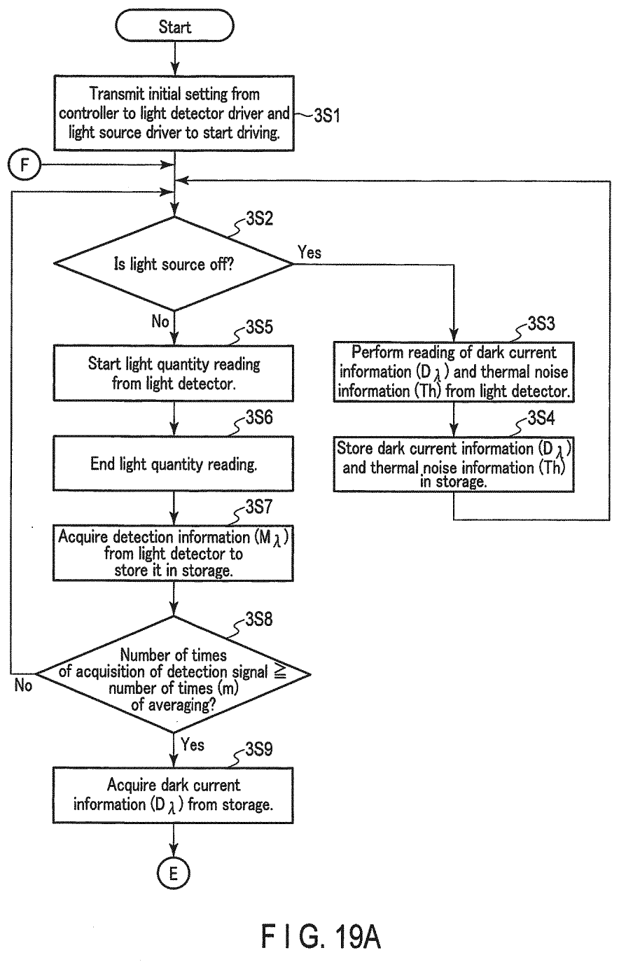

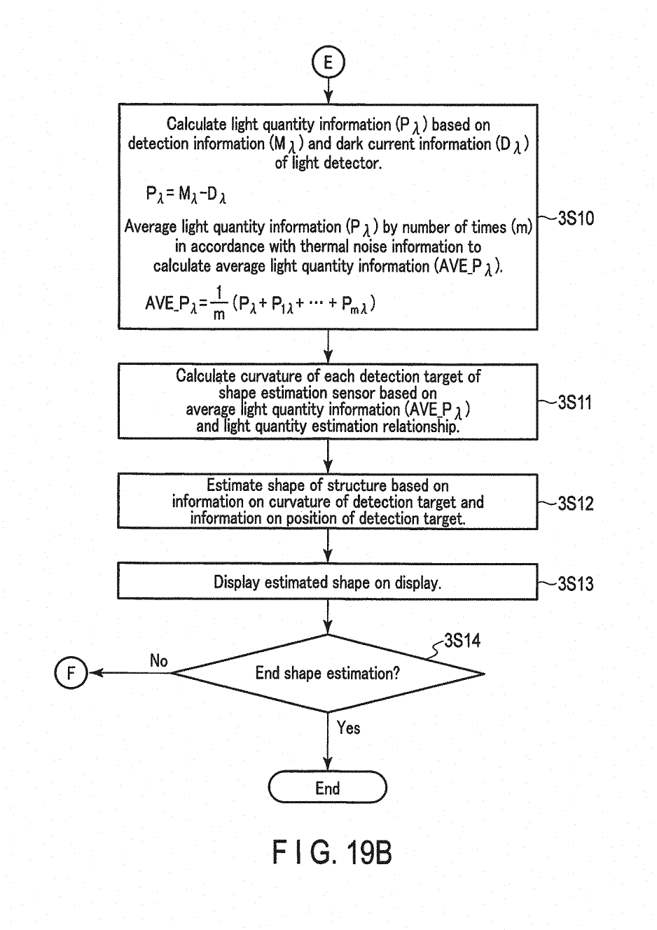

FIGS. 19A and 19B show a flowchart of the shape estimation operation in the present embodiment.

In step 3S1, in response to the shape estimation start signal from the input device 170, the controller 200 transmits initial settings to the light detector driver 180 and the light source driver 190 to start driving the light detector 30 and the light source 10. The light source 10 is repeatedly turned on/off based on sequence control. At the start of driving of the light source 10, first, the light source 10 is turned off.

In step 3S2, it is determined whether the light source 10 is off. Specifically, it is determined whether the light source on/off signal transmitted from the light source driver 190 to the light source 10 through the output unit 140 is a light source off signal. If the judgment result is “Yes”, dark current measurement and thermal noise measurement are performed. In contrast, when the judgment result is “No”, light quantity measurement for shape estimation is performed.

If the determination result in step 3S2 is “Yes”, in step 3S3, the dark current information (D_{λ}) and the thermal noise information (Th) from the light detector 30 are read. This means performing light quantity reading with the light detector 30 in the same manner as in steps 3S5 and 3S6 and reading the detection information of the light detector 30 as dark current information (D_{λ}). If dark current information (D_{λ}) is read some times, the average is taken as the current dark current information (D_{λ}). Further, the thermal noise information (Th) is calculated from the standard deviation or the like of pieces of detection information.

Subsequently, in step 3S4, the dark current information (D_{λ}) and the thermal noise information (Th) of the light detector 30 are stored in the storage 120. Thereafter, the process returns to step 3S2. At this time, a light source on signal is transmitted from the light source driver 190 to the light source 10 through the output unit 140, and the light source 10 is turned on.

If the result of the determination in step 3S2 is “No”, then in step 3S5 the light quantity reading from the light detector 30 is started.

In step 3S6, the light detector 30 ends the light quantity reading, and then outputs a light quantity reading end signal.

In accordance with the light quantity reading end signal, detection information (M_{λ}) from the light detector 30 is acquired in step 3S7. Furthermore, the acquired detection information (M_{λ}) is stored in the storage 120. At this time, a light source off signal is transmitted from the light source driver 190 to the light source 10 through the output unit 140, and the light source 10 is turned off.

In step 3S8, the number of times (m) of averaging the light quantity information (P_{λ}) is determined according to the thermal noise information (Th), and the number of times of acquisition of the detection information (M_{λ}) from the light detector 30 is equal to or more than the number of times (m). If the determination result is “No”, the process returns to step 3S2. If the judgment result is “Yes”, shape estimation is performed.

If the determination result in step 3S8 is “Yes”, in step 3S9, detection information (M_{λ}) from the light detector 30 is acquired from the storage 120, the dark current information (D_{λ}) is acquired from the dark current storage 124, and the thermal noise information (Th) is acquired from the thermal noise storage 126. As described above, the dark current information (D_{λ}) is calculated by averaging pieces of detection information of the light detector 30 acquired when the light source 10 is in the off state, and then stored in the dark current storage 124. Further, the thermal noise information (Th) is calculated from the standard deviation or the like of pieces of detection information acquired when the light source 10 is in the off state, and then stored in the thermal noise storage 126.

Subsequently, in step 3S10, light quantity information (P_{λ}) is calculated based on the detection information (M_{λ}) from the light detector 30 and the dark current information (D_{λ}). The light quantity information (P_{λ}) is calculated as the difference between the detection information (M_{λ}) and the dark current information (D_{λ}) according to the following equation (6).

P_{λ}=M_{λ}−D_{λ} (6)

Further, average light quantity information (AVE_P_{λ}) is calculated. The average light quantity information (AVE_P_{λ}) is calculated by averaging the light quantity information (P_{λ}) by the number of times (m) of averaging determined according to the thermal noise information (Th) according to the following equation (7).

$${AVE\_P}_{λ} = \frac{1}{m} ( {P}_{λ} + {P}_{1 λ} + … + {P}_{( m - 1 ) λ} ) \qquad ( 7 )$$

In step 3S11, the curvature of each detection target DPᵢ of the shape estimation sensor 20 is calculated based on the average light quantity information (AVE_P_{λ}) and the light quantity estimation relationship acquired from the storage 120.

In step 3S12, the shape of the light guide LG₂ of the shape estimation sensor 20, that is, the shape of the structure in which the shape estimation sensor 20 is incorporated, is estimated based on the information on the curvature of each detection target DPᵢ and the information on the position of each detection target DPᵢ acquired from the storage 120.

In step 3S13, the estimated shape of the light guide LG₂, that is, the structure is displayed on the display 160.

In step 3S14, it is determined whether or not to finish the shape estimation. If the determination result is “No”, the process returns to step 3S2. If the judgment result is “Yes”, shape estimation is ended.

As with the first embodiment, the shape estimation apparatus according to the present embodiment removes the influence of noise (dark current and thermal noise) from the detection information acquired from the light detector 30, so that calculation of the curvature of each of the detection targets DPᵢ of the shape estimation sensor 20 and estimation of the shape of the light guide LG₂ can be performed with high accuracy. Accordingly, the shape of the flexible structure in which the shape estimation sensor 20 is incorporated can be estimated with high accuracy. As a result, a shape estimation apparatus configured to estimate an accurate shape free of errors due to temperature-dependent noise is provided.

<Fourth Embodiment>

The hardware configuration of the shape estimation apparatus of the present embodiment is the same as the hardware configuration of the shape estimation apparatus of the third embodiment.

[Arithmetic Processing Unit (Processor and its Periphery)]

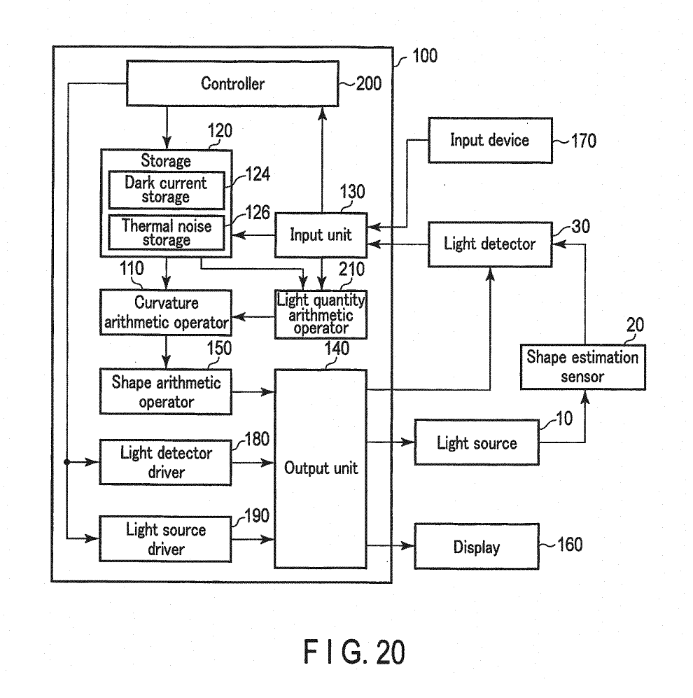

Then, the arithmetic processing unit of the shape estimation apparatus of the present embodiment is described. FIG. 20 shows the processor 100 and its periphery An the present embodiment. The configuration of the processor 100 in the present embodiment is basically the same as the processor 100 in the third embodiment. The differences will be described below.

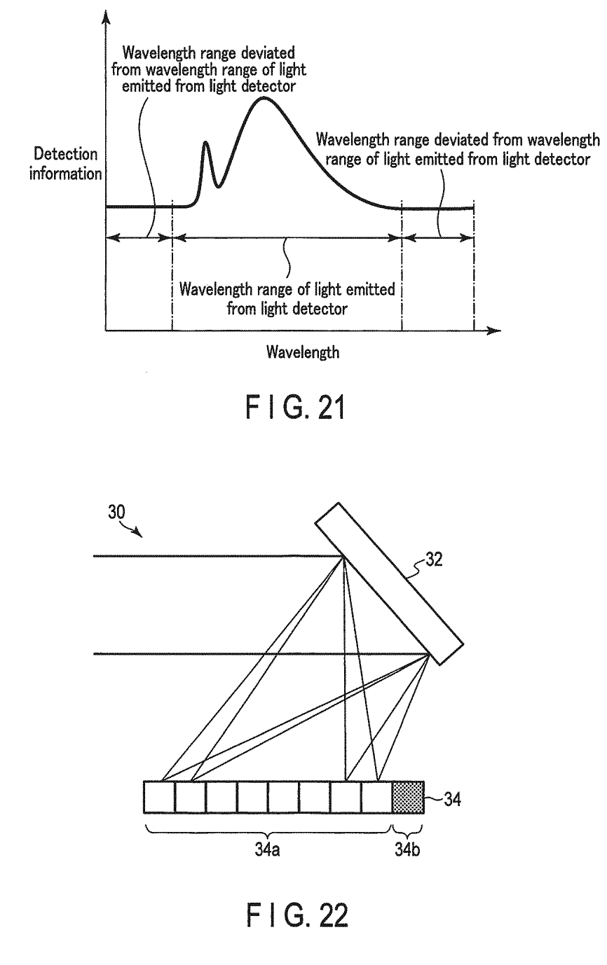

Unlike the third embodiment, the light source 10 is not repeatedly turned on/off. The light emitted from the light source 10 and passing through the shape estimation sensor 20 enters the light detector 30, and the light quantity is detected by the light detector 30. The detection information from the light detector 30 is transmitted to the light quantity arithmetic operator 210 through the input unit 130. The light quantity arithmetic operator 210 extracts detection information of a wavelength range (short wavelength side and/or long wavelength side) deviated from the wavelength range of light emitted from the light source 10 among the received detection information. FIG. 21 shows the relationship between the detection information from the light detector 30 and the wavelength range of the light emitted from the light source 10. The detection information of the wavelength range deviated from the wavelength range of the light emitted from the light source 10 is the information of the dark current and the thermal noise of the light detector 30.

The light quantity arithmetic operator 210 further calculates the average value of the detection information (M_{λ}) of the wavelength range (λ: A to B, the number N of data) deviated from the wavelength range of the light emitted from the light source 10 according to the following equation (8) as dark current information (D_{λ}), and is transmitted to the storage 120. The dark current information (D_{λ}) is stored in the dark current storage 124 in the storage 120.

$${D}_{λ} = \frac{1}{N} {\sum }_{λ = A}^{B} {M}_{λ} \qquad ( 8 )$$

The light quantity arithmetic operator 210 also calculates the thermal noise information (Th) of the light detector 30 from the standard deviation of the difference between the detection information (M_{λ}) of the wavelength range (λ: A to B, the number of data N) deviated from the wavelength range of the light emitted from the light source 10 and the dark current information (D_{λ}) according to the following equation (9), and is transmitted to the storage 120. The thermal noise information (Th) is stored in the thermal noise storage 126 in the storage 120.

$$Th = {\sum }_{λ = A}^{B} \sqrt{\frac{{M}_{λ} - {D}_{λ}}{N}} \qquad ( 9 )$$

The light quantity arithmetic operator 210 calculates a difference obtained by subtracting the dark current information (D_{λ}) read from the dark current storage 124 from the detection information (M_{λ}) of the wavelength range of light emitted from the light source 10 according to the following equation (10) as light quantity information (P_{λ}).

P_{λ}=M_{λ}−D_{λ}) (10)

The light quantity arithmetic operator 210 calculates the average light quantity information (AVE_P_{λ}) by performing time averaging of the number of times (m) determined from the thermal noise information (Th) read from the thermal noise storage 126 according to the following equation (11).

$${AVE\_P}_{λ} = \frac{1}{m} ( {P}_{λ} + {P}_{1 λ} + … + {P}_{( m - 1 ) λ} ) \qquad ( 11 )$$

The curvature arithmetic operator 110 calculates curvatures of the detection targets DPᵢ based on the average light quantity information (AVE_P_{λ}) from the light quantity arithmetic operator 210 and the light quantity estimation relationship stored in the storage 120. The curvature arithmetic operator 110 outputs the calculated curvatures of the detection targets DPᵢ to the shape arithmetic operator 150.

The shape arithmetic operator 150 calculates shape information of the light guide LG₂ provided with detection targets DPᵢ based on the curvature of each detection target DPᵢ and the information of the position stored in the storage 120. The shape arithmetic operator 150 transmits the shape information of the light guide LG₂ to the display 160 through the output unit 140.

The display 160 displays the shape information of the light guide LG₂ as a curved shape of a flexible structure in which the shape estimation sensor 20 including the light guide LG₂ is incorporated.

(Modifications)

In the present embodiment, the dark current information and the thermal noise information are acquired based on the detection information from the light detector 30 included in the wavelength range deviated from the wavelength range of the light emitted from the light source 10. However, it may be configured that the light emitted from the light source 10 does not enter a part of the light receiving element in the light detector 30, and the dark current information and the thermal noise information is acquired based on the output from the part of the light receiving element that the light does not enter.

FIG. 22 shows a partial configuration of the light detector 30 with such a configuration. The light detector 30 of this modified example has, for example, a crating 32 as a spectral element and a light receiving element 34 as a photoelectric conversion element. A part of the cell area 34a of the light receiving element is disposed at a position where the light separated by the grating 32 enters, and another part of the cell area 34b of the light receiving element 34 is disposed at a position deviated from the position where the light separated by the grating 32 enters. The detection information output from the cell area 34b of the light receiving element 34 reflects the dark current information and the thermal noise information. Therefore, it is possible to obtain dark current information and thermal noise information based on the detection information output from the cell area 34b.

The cell area 34b may be configured by only one cell or may include cells. It is preferable that a light absorber or the like be applied to a cell or cells of the cell area 34b or a mask for shielding light be provided. In this case, a cell or cells of the cell area 34b may be disposed at positions where the light dispersed by the grating 32 enters, as long as the detection of the curvature of the detection target is not impeded.

[Flowchart of Shape Estimation]

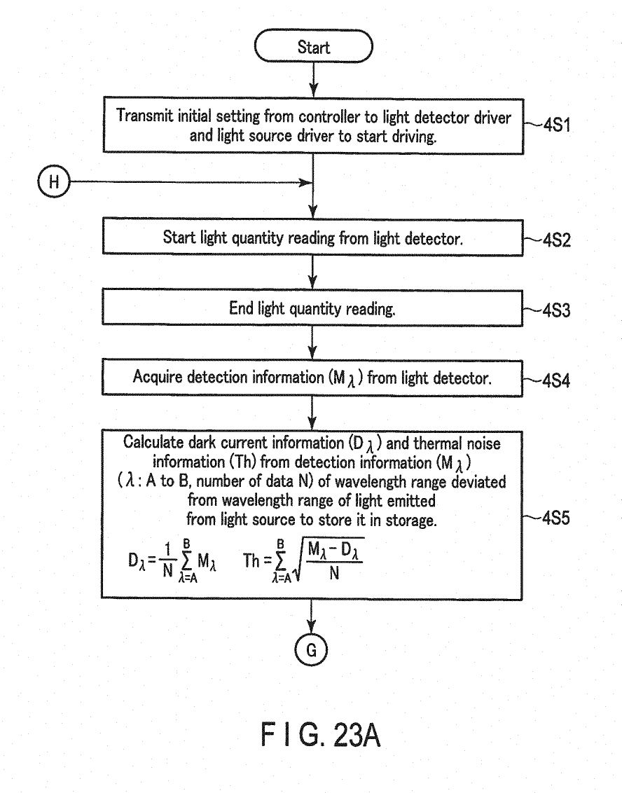

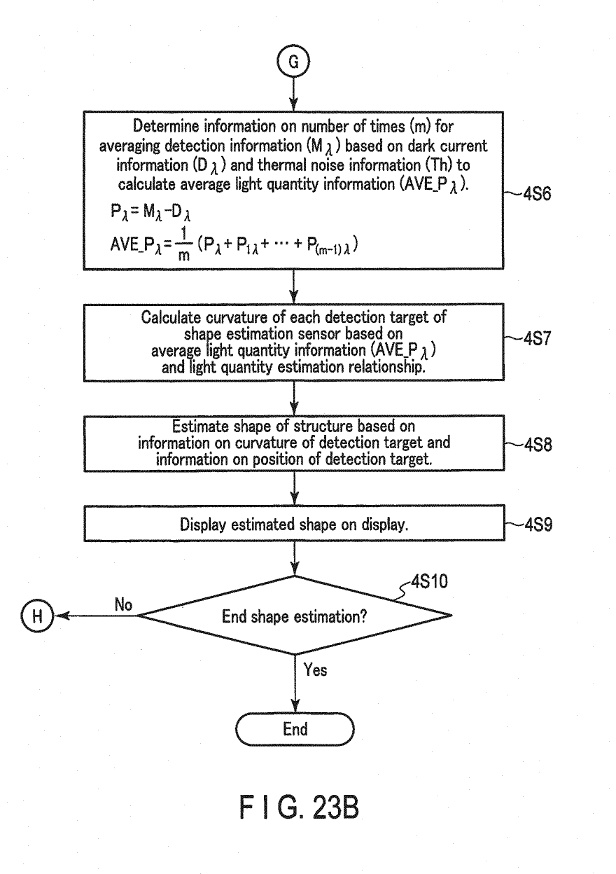

FIGS. 23A and 23B show a flowchart of the shape estimation operation in the present embodiment.

In step 4S1, in response to the shape estimation start signal from the input device 170, the controller 200 transmits initial settings to the light detector driver 180 and the light source driver 190 to start driving the light detector 30 and the light source 10.

In step 4S2, the light quantity reading from the light detector 30 is started.

In step 4S3, the light detector 30 ends the light quantity reading, and then outputs a light quantity reading end signal.

In accordance with the light quantity reading end signal, detection information (M_{λ}) from the light detector 30 is acquired in step 4S4.

In step 4S5, the dark current information (D_{λ}) and the thermal noise information (Th) are calculated from the detection information (M_{λ}) of the wavelength range (λ: A to B, data number N) deviated from the wavelength range of the light emitted from the light source 10. The dark current information (D_{λ}) is calculated according to the above equation (8), and then stored in the dark current storage 124 in the storage 120. The thermal noise information (Th) is calculated according to the above equation (9), and then stored in the thermal noise storage 126 in the storage 120.

In step 4S6, the light quantity arithmetic operator 210 calculates light quantity information (P_{λ}) as a difference obtained by subtracting the dark current information (D_{λ}) read from the dark current storage 124 from the detection information (M_{λ}) of the wavelength range of light emitted from the light source 10 according to the following equation (10) described above. Further, the number of times (m) of averaging the light quantity information (P_{λ}) is determined from the thermal noise Information (Th) read from the thermal noise storage 126 and the average light quantity information (AVE_P_{λ}) is calculated according to the equation (11) described above. The calculation of average light quantity information cannot be performed until m pieces of light quantity information are obtained, and the following steps 4S7 to 4S9 are skipped.

In step 4S7, the curvature of each detection target DPᵢ of the shape estimation sensor 20 is calculated based on the average light quantity information (AVE_P_{λ}) from the light quantity arithmetic operator 210 and the light quantity estimation relationship acquired from the storage 120.

In step 4S8, the shape of the light guide LG₂ of the shape estimation sensor 20, that is, the shape of the structure in which the shape estimation sensor 20 is incorporated, is estimated based on the information on the curvature of each detection target DPᵢ and the information on the position of each detection target DPᵢ acquired from the storage 120.

In step 4S9, the estimated shape of the light guide LG₂, that is, the structure is displayed on the display 160.

In step 4S10, it is determined whether or not to finish the shape estimation. If the determination result is “No”, the process returns to step 4S2. If the judgment result is “Yes”, shape estimation is ended.

The shape estimation apparatus according to the present embodiment removes the influence of noise (dark current and thermal noise) from the detection information acquired from the light detector 30, so that calculation of the curvature of each of the detection targets DPᵢ of the shape estimation sensor 20 and estimation of the shape of the light guide LG₂ can be performed with high accuracy. Accordingly, the shape of the flexible structure in which the shape estimation sensor 20 is incorporated can be estimated with high accuracy. As a result, a shape estimation apparatus configured to estimate an accurate shape free of errors due to temperature-dependent noise is provided.

<Fifth Embodiment>

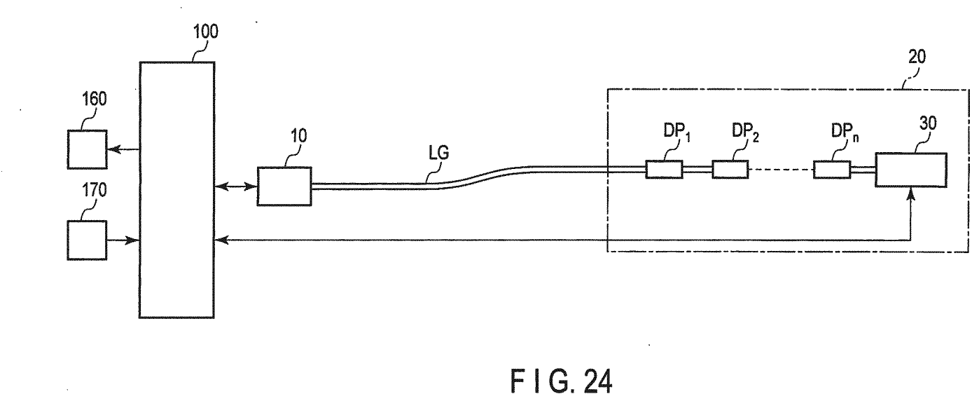

FIG. 24 is a configuration drawing of a shape estimation apparatus according to a fifth embodiment. In FIG. 24, members denoted with the same reference signs as the members shown in FIG. 1 are the same members, and the detailed description thereof will be omitted. Hereinafter, the fifth embodiment will be described focusing on differences from the first embodiment.

Unlike the first embodiment, the shape estimation apparatus of the present embodiment does not employ a reflection type but employs a transmission type. For this reason, the hardware configuration of the shape estimation apparatus of the present embodiment does not include the light branching unit 50, the anti-reflection member 60, and the reflection member 40 as compared with the hardware configuration of the shape estimation apparatus of the first embodiment. Also, the temperature measuring device 70 is omitted.

A light guide LG is optically connected to the light source 10. The light guide LG extends to the inside of the shape estimation sensor 20. Within the shape estimation sensor 20, the light guide LG is provided with detection targets DPᵢ. A light detector 30 configured to detect light having passed through the shape estimation sensor 20 is optically connected to the distal end of the light guide LG.

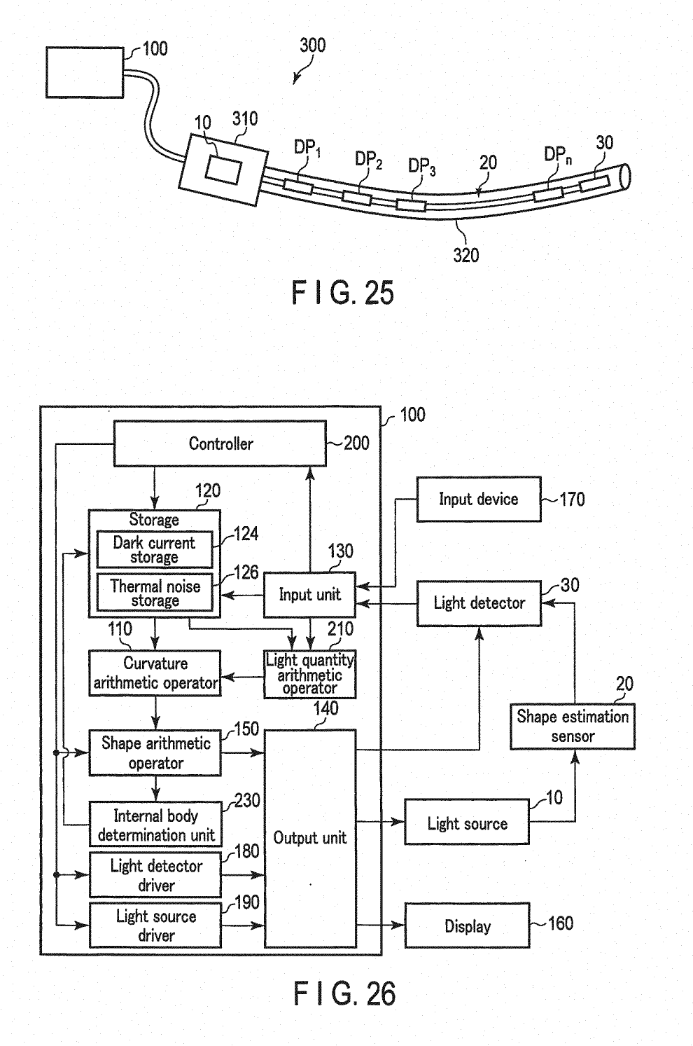

FIG. 25 schematically shows an endoscope apparatus in which the shape estimation apparatus of the present embodiment is incorporated. The endoscope apparatus 300 includes a grip section 310 for the operator to grip the endoscope apparatus 300, and an insertion section 320 extending from the grip section 310. The insertion section 320 is, for example, a hollow elongated flexible structure to be inserted into a lumen in the human body. In the internal space of the insertion section 320, the shape estimation sensor 20 according to the present embodiment is provided. The shape estimation sensor 20 extends along the insertion section 320. The light detector 30 is disposed at the distal end of the insertion section 320. For example, the light source 10 is disposed in the grip section 310. The processor 100 is disposed outside the grip section 310 and connected to the grip section 310 through a cable.

[Arithmetic Processing Unit (Processor and its Periphery)]

The arithmetic processing unit of the shape estimation apparatus of the present embodiment will be described. FIG. 26 shows the processor 100 and its periphery in the present embodiment. The configuration of the processor 100 in the present embodiment is basically the same as the processor 100 in the first embodiment. The differences will be described below.

The processor 100 of the shape estimation apparatus of the present embodiment includes an internal body determination unit 230 configured to determine whether or not the insertion section 320 of the endoscope apparatus 300 is currently inserted in a lumen in a human body.

The internal body determination unit 230 determines whether or not the insertion section 320 of the endoscope apparatus 300 is currently inserted into a tubular space in the body, in brief, whether it is in the body or not, based on the shape information of the shape estimation sensor 20 calculated by the shape arithmetic operator 150. This determination is performed based on whether the insertion section 320 has a characteristic shape.

For example, the insertion section 320 may be S-shaped when being inserted into a lumen, for example when positioned in the sigmoid colon. The internal body determination unit 230 determines, from the shape information of the light guide LG, whether or not the insertion section 320 has an S shape. If the internal body determination unit 230 determines that the insertion section 320 has an S shape, it determines that the insertion section 320 is in the body. If it is determined that the insertion section 320 is in the body, the internal body determination unit 230 transmits, to the storage 120, a signal indicating that the insertion section 320 is in the body (hereinafter referred to as an internal body signal).

When the storage 120 receives the internal body signal from the internal body determination unit 230, the dark current information of the light detector 30 set in advance corresponding to the internal body temperature (35 to 37° C.) stored in the thermal noise storage 126 is transmitted to the light quantity arithmetic operator 210.

Instead of the internal body determination unit 230 determining whether or not the insertion section 320 is in the body, and then outputting the internal body signal to the storage 120, information indicating that the insertion section 320 is in the body may be entered manually from the input device 170 to the storage 120 in the processor 100. Alternatively, instead of inputting the information indicating that the insertion section 320 is in the body into the storage 120, the temperature information in the periphery of the light detector 30 may be directly input.

The light quantity arithmetic operator 210 calculates light quantity information by subtracting dark current information corresponding to the internal body temperature stored in the storage 120 from the detection information from the light detector 30. The light quantity arithmetic operator 210 further calculates the light quantity information by performing time averaging (may be adjacent pixels) of the number of times determined by the thermal noise information corresponding to body temperature stored in the thermal noise storage 126, and then outputs the light quantity information to the curvature arithmetic operator 110.

The curvature arithmetic operator 110 calculates the curvatures of the detection targets DPᵢ based on the average light quantity information from the light quantity arithmetic operator 210 and the light quantity estimation relationship stored in the storage 120, and then outputs the curvatures to the shape arithmetic operator 150.

The shape arithmetic operator 150 calculates the shape information of the light guide LG provided with the detection targets DPᵢ based on the curvature of each detection target DPᵢ and the information of the position stored in the storage 120. The shape arithmetic operator 150 transmits the shape information of the light guide LG to the display 160 through the output unit 140.

The display 160 displays the shape information of the light guide LG as a curved shape of the insertion section 320 in which the shape estimation sensor 20 is incorporated.

[Flowchart of Shape Estimation]

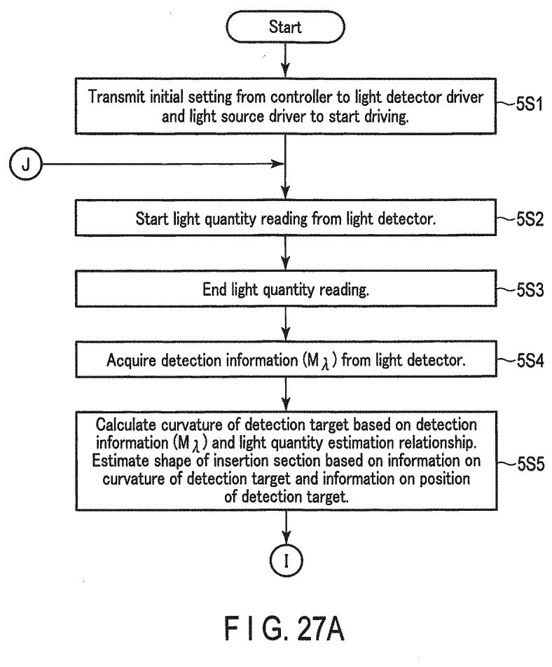

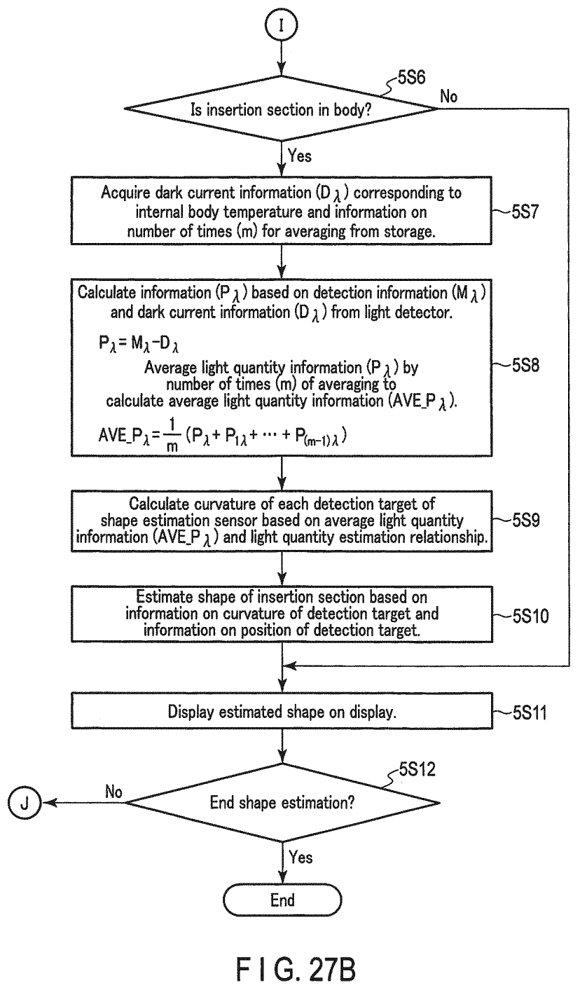

FIGS. 27A and 27B show a flowchart of the shape estimation operation in the present embodiment.

In step 5S1, in response to the shape estimation start signal from the input device 170, the controller 200 transmits initial settings to the light detector driver 180 and the light source driver 190 to start driving the light detector 30 and the light source 10.

In step 5S2, the light quantity reading from the light detector 30 is started.

In step 5S3, the light detector 30 ends the light quantity reading, and then outputs a light quantity reading end signal.

In accordance with the light quantity reading end signal, detection information (M_{λ}) from the light detector 30 is acquired in step 5S4. Furthermore, the acquired detection information (M_{λ}) is stored in the storage 120.

In step 5S5, the curvature of each detection target DPᵢ of the shape estimation sensor 20 is calculated based on the detection information (M_{λ}) from the light detector 30 and the light quantity estimation relationship acquired from the storage 120. Furthermore, based on the information on the curvature of each detection target DPᵢ and the information on the position of each detection target DPᵢ acquired from the storage 120, the shape of the light guide LG of the shape estimation sensor 20, that is, the shape of the insertion section 320, which is a structure in which the shape estimation sensor 20 is incorporated, is estimated.

In step 5S6, it is determined whether the insertion section 320 is in the body. Specifically, it is determined whether the light guide LG in the shape estimation sensor 20 is S-shaped.

If the determination result in step 5S6 is “No”, the process proceeds to step 5S11.

If the result of the determination in step 5S6 is “Yes”, dark current information (D_{λ}) corresponding to the internal body temperature is obtained from the dark current storage 124 in the storage 120 in step 5S7. Further, the number of times of averaging the light quantity information (P_{λ}) obtained by subtracting the dark current information (D_{λ}) from the detection information (M_{λ}) from the light detector 30 is determined.

Subsequently, in step 5S8, according to the following equation (12), the dark current information (D_{λ}) is subtracted from the detection information (M_{λ}) from the light detector 30 to calculate light quantity information (P_{λ}), and then stored in the storage 120.

P_{λ}=M_{λ}−D_{λ} (12)

Further, according to the following equation (13), the light quantity information (P_{λ}) is averaged by the number of times (m) of averaging to calculate the average light quantity information (AVE_P_{λ}).

$${AVE\_P}_{λ} = \frac{1}{m} ( {P}_{λ} + {P}_{1 λ} + … + {P}_{( m - 1 ) λ} ) \qquad ( 13 )$$

Note that the average light quantity information is calculated from m or less pieces of currently acquired light quantity information until m pieces of light quantity information is obtained.

In step 5S9, the curvature of each detection target DPᵢ of the shape estimation sensor 20 is calculated based on the average light quantity information (AVE_P_{λ}) and the light quantity estimation relationship acquired from the storage 120.

In step 5S10, based on the curvature of each shape detection target DPᵢ and the position information of each shape detection target DPᵢ acquired from the storage 120, the shape of the light guide LG in the shape estimation sensor 20, that is, the shape of the insertion section 320, which is a structure in which the shape estimation sensor 20 is incorporated, is estimated.

In step 5S11, the shape of the insertion section 320 of the endoscope apparatus 300 estimated in step 5S5 or step 5S11 is displayed on the display 160. Although the shape estimated in step 5S5 includes an error due to temperature-dependent noise, the influence of the error does not matter so much because the insertion section 320 is not inserted in the body.

In step 5S12, it is determined whether or not to finish the shape estimation. If the determination result is “No”, the process returns to step 5S2. If the judgment result is “Yes”, shape estimation is ended.

As with the first embodiment, the shape estimation apparatus according to the present embodiment removes the influence of noise (dark current and thermal noise) from the detection information acquired from the light detector 30, so that calculation of the curvature of each of the detection targets DPᵢ the shape estimation sensor 20 and estimation of the shape of the light guide LG can be performed with high accuracy. Accordingly, the shape of the insertion section 320 in which the shape estimation sensor 20 is incorporated can be estimated with high accuracy. As a result, a shape estimation apparatus configured to estimate an accurate shape free of errors due to temperature-dependent noise is provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A shape estimation apparatus configured to estimate a curved shape of a flexible structure, the apparatus comprising:
a light guide incorporated in the flexible structure and configured to guide light emitted from a light source;
a detection target provided in the light guide and configured to change a light quantity of light guided by the light guide according to the curved state of the light guide;
a light detector including a light receiving element and configured to receive the light that has been changed in a light quantity by the detection target to detect the light quantity; and
a curvature arithmetic operator configured to calculate information related to a curve of the light guide based on the detected light quantity,
the light receiving element including a part that the light from the light source does not enter,
the curvature arithmetic operator calculating information related to the curve of the light guide in which an error of the light detector caused by noise containing dark current of the light detector is corrected based on an output of the part of the light receiving element that the light from the light source does not enter.

2. The shape estimation apparatus according to claim 1, wherein
the noise includes thermal noise of the light detector,
the apparatus further comprises a temperature measuring device configured to measure a temperature in the periphery of the light detector, and
the curvature arithmetic operator is configured to calculate the information related to the curve of the light guide in which the error is corrected based on information on temperature measured by the temperature measuring device.

3. The shape estimation apparatus according to claim 1, wherein the noise includes the dark current and the thermal noise of the light detector, and the correction of en error caused by the dark current and the thermal noise of the light detector is performed according to dark current information and thermal noise information acquired by measuring the dark current and the thermal noise at a given timing.

4. The shape estimation apparatus according to claim 3, further comprising a shutter configured to block light passing through the light guide to enter the light detector when necessary, wherein measurement of the dark current and the thermal noise of the light detector is performed based on an output of the light detector when the shutter is closed.

5. The shape estimation apparatus according to claim 3, wherein measurement of the dark current and the thermal noise of the light detector is performed based on an output when the light source is in an off state.

6. A shape estimation apparatus configured to estimate a curved shape of a flexible structure, the apparatus comprising:
a light guide incorporated in the flexible structure and configured to guide light emitted from a light source;
a detection target provided in the light guide and configured to change a light quantity of light guided by the light guide according to the curved state of the light guide;
a light detector configured to receive the light that has been changed in a light quantity by the detection target to detect the light quantity; and
a curvature arithmetic operator configured to calculate information related to a curve of the light guide based on the detected light quantity,
the curvature arithmetic operator calculating information related to the curve of the light guide in which an error of the light detector caused by noise containing dark current of the light detector is corrected based on an output of the light detector corresponding to a wavelength range deviated from a wavelength range of the light emitted from the light source.

7. The shape estimation apparatus according to claim 1, wherein estimation of the dark current of the light detector is corrected according to the shape of the detection target.

8. An endoscope apparatus in which the shape estimation apparatus according to claim 1 is incorporated.

9. The endoscope apparatus according to claim 8, wherein the light detector is disposed at a distal end of an insertion section of the endoscope apparatus.

10. A shape estimation method of estimating a curved shape of a flexible structure, the method comprising:
supplying light to a light guide incorporated in the flexible structure, the light guide having a detection target configured to change a light quantity of the light guided by the light guide according to the curved state of the light guide;
detecting the light quantity that has been changed by the detection target by a light detector including a light receiving element including a part that the light does not enter; and
calculating information related to the curve of the light guide in which an error of the light detector caused by noise containing dark current of the light detector is corrected based on an output of the part of the light receiving element that the light does not enter.

11. The shape estimation method according to claim 10, wherein
the noise includes thermal noise of the light detector,
the method further comprises measuring a temperature in the periphery of the light detector, and
the calculating information related to the curve of the light guide calculates the information related to the curve of the light guide in which the error is corrected based on information on the measured temperature.

12. The shape estimation method according to claim 10, wherein the noise includes the dark current and the thermal noise of the light detector, and the method comprises measuring the dark current and the thermal noise at a given timing to acquire dark current information and thermal noise information, and correcting an error caused by the dark current and the thermal noise of the light detector according to the acquired dark current information and thermal noise information.

13. The shape estimation method according to claim 12, the measuring the dark current and the thermal noise includes blocking light passing through the light guide to enter the light detector when necessary, and measurement of the dark current and the thermal noise of the light detector is performed based on an output of the light detector when the light is blocked.

14. The shape estimation method according to claim 12, further comprising stopping supply of the light to the light guide when necessary, wherein measurement of the dark current and the thermal noise of the light detector is performed based on an output when the supply of the light to the light guide is stopped.

15. The shape estimation method according to claim 10, wherein estimation of the dark current of the light detector is corrected according to the shape of the detection target.

16. An observation method using an endoscope apparatus, the observation method performing the shape estimation method according to claim 10.

17. The observation method according to claim 16, wherein the light detector is disposed at a distal end of an insertion section of the endoscope apparatus.
